(19) United States
(12) Patent Application Publication
(10) Pub. No.: US 2015/0269346 A1
(43) Pub. Date: Sep. 24, 2015

(54) MINING TRANSACTION DATA FOR HEALTHINESS INDEX

(71) Applicant: MasterCard International Incorporated, Purchase, NY (US)

(72) Inventor: Edward Lee, Scarsdale, NY (US)

(73) Assignee: MasterCard International Incorporated, Purchase, NY (US)

(21) Appl. No.: 14/223,530

(22) Filed: Mar. 24, 2014

(51) Int. Cl. G06F 19/00; G06Q 30/02; G06Q 40/00

(52) U.S. Cl. CPC G06F 19/3431; G06Q 40/00; G06Q 30/0255; G06F 19/3493

(57) ABSTRACT

A database of payment card transaction data and a database of merchant data are accessed. Per-capita spending for at least two categories of merchants with transaction data in the database is determined for at least one payment card account for a predetermined time period. Patronizing one category of merchants is associated with good cardholder health, while patronizing the second category of merchants is associated with bad cardholder health. An overall healthiness index score is determined for the at least one payment card account for the predetermined time period, based on comparison of the determined per-capita spending at the categories of merchants to respective baseline values.

### FIELD OF THE DISCLOSURE

The present disclosure relates generally to the electronic and computer arts, and, more particularly, to apparatus and methods for analysis of electronic payment data.

### BACKGROUND OF THE DISCLOSURE

The use of payment cards, such as credit cards, debit cards, and pre-paid cards, has become ubiquitous. Most payment card accounts have one or more associated physical cards; however, the use of non-traditional payment devices, such as appropriately-configured “smart” cellular telephones, is increasing. A wealth of transaction data is available based on the use of payment card accounts.

Data mining includes the discovery of patterns in large data sets.

### SUMMARY OF THE DISCLOSURE

Principles of the disclosure provide techniques for mining transaction data for a “healthiness index.” In one aspect, an exemplary method includes the steps of accessing a database of payment card transaction data and a database of merchant data; determining per-capita spending at a first plurality of merchants for at least one payment card account for a predetermined time period, the first plurality of merchants having transaction data in the database of payment card transaction data, patronizing the first plurality of merchants being associated with good cardholder health; determining per-capita spending at a second plurality of merchants for the at least one payment card account for the predetermined time period, the second plurality of merchants having transaction data in the database of payment card transaction data, patronizing the second plurality of merchants being associated with bad cardholder health; and determining an overall healthiness index score for the at least one payment card account for the predetermined time period, based on comparison of the determined per-capita spending at the first plurality of merchants for the at least one payment card account for the predetermined time period and the determined per-capita spending at the second plurality of merchants for the at least one payment card account for the predetermined time period to respective baseline values.

Aspects of the disclosure contemplate the method(s) performed by one or more entities herein, as well as facilitating one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the disclosure or elements thereof can be implemented in the form of a computer program product including a tangible computer readable recordable storage medium with computer usable program code for performing the method steps indicated stored thereon in a non-transitory manner. Furthermore, one or more embodiments of the disclosure or elements thereof can be implemented in the form of a system (or apparatus) including a memory and at least one processor that is coupled to the memory and operative to perform exemplary method steps. Yet further, in another aspect, one or more embodiments of the disclosure or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the disclosure can provide substantial beneficial technical effects; for example:
An indexing method that is a benchmarking using transactional purchase data to determine behavior; the indexing is a combination of quantitative summaries and qualitative determination of what “healthiness” is and/or how “healthiness” is defined.
Assisting governmental or other authorities in quickly identifying public health risks such as epidemiological risks.

These and other features and advantages of the present disclosure will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement techniques of the disclosure;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, as well as an exemplary database, useful in connection with one or more embodiments of the disclosure;

FIG. 3 is a flow chart of an exemplary method, in accordance with an aspect of the disclosure;

FIG. 4 is a block diagram of an exemplary system, in accordance with an aspect of the disclosure;

FIG. 5 is a block diagram of an exemplary computer system useful in one or more embodiments of the disclosure;

FIG. 6 is a non-limiting illustrative example of calculations in accordance with an aspect of the disclosure;

FIGS. 7-9 are non-limiting exemplary alternative techniques for determining per-capita spending at different categories of merchants, in accordance with aspects of the disclosure;

FIG. 10 is an exemplary method for determining comparison baselines, in accordance with an aspect of the disclosure;

FIG. 11 is a block diagram illustrating a system for aggregating consumer spending behaviors in accordance with exemplary embodiments of U.S. patent application Ser. No. 13/721,216;

FIG. 12 is a block diagram illustrating the processing server of the system of FIG. 6 in accordance with exemplary embodiments of U.S. patent application Ser. No. 13/721,216;

FIG. 13 is a block diagram illustrating the consumer database of FIG. 6 in accordance with exemplary embodiments of U.S. patent application Ser. No. 13/721,216;

FIG. 14 is a block diagram illustrating the geographic database of FIG. 6 in accordance with exemplary embodiments of U.S. patent application Ser. No. 13/721,216;

FIG. 15 is a diagram illustrating a plurality of geographic areas and corresponding geographic centroids in accordance with exemplary embodiments of U.S. patent application Ser. No. 13/721,216;

FIG. 16 is a diagram illustrating a plurality of financial transactions and identification of a purchase centroid in accordance with exemplary embodiments of U.S. patent application Ser. No. 13/721,216;

FIG. 17 is a diagram illustrating the identification of a predetermined number of geographic centroids in accordance with exemplary embodiments of U.S. patent application Ser. No. 13/721,216;

FIG. 18 is a flow chart illustrating a method for aggregating consumer spending behaviors in geographic areas in accordance with exemplary embodiments of U.S. patent application Ser. No. 13/721,216; and

FIG. 19 is a flow chart illustrating an exemplary method for assigning consumer behaviors to geographic areas in accordance with exemplary embodiments of U.S. patent application Ser. No. 13/721,216.

### DETAILED DESCRIPTION OF PREFERRED EMBODIMENTS

### Payment Devices and Associated Payment Processing Networks

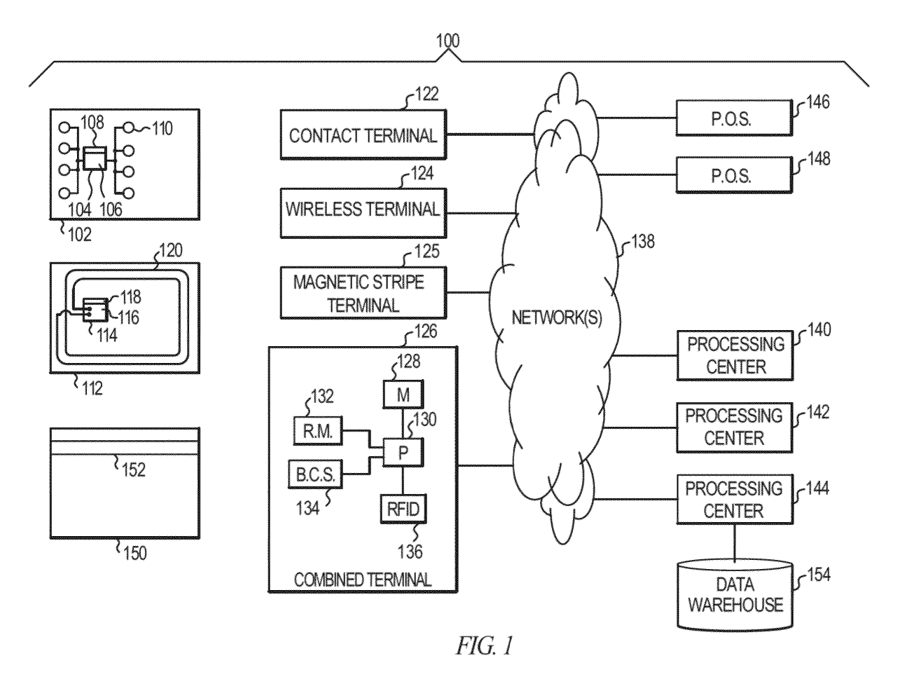

Attention should now be given to FIG. 1, which depicts an exemplary embodiment of a system 100, according to an aspect of the disclosure, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 per se may function with other types of devices in lieu of or in addition to “smart” or “chip” cards 102, 112; for example, a conventional magnetic stripe device 150, such as a card having a magnetic stripe 152. Furthermore, an appropriately configured mobile device (e.g., “smart” cellular telephone handset, tablet, personal digital assistant (PDA), and the like) can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present disclosure is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (trademarks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

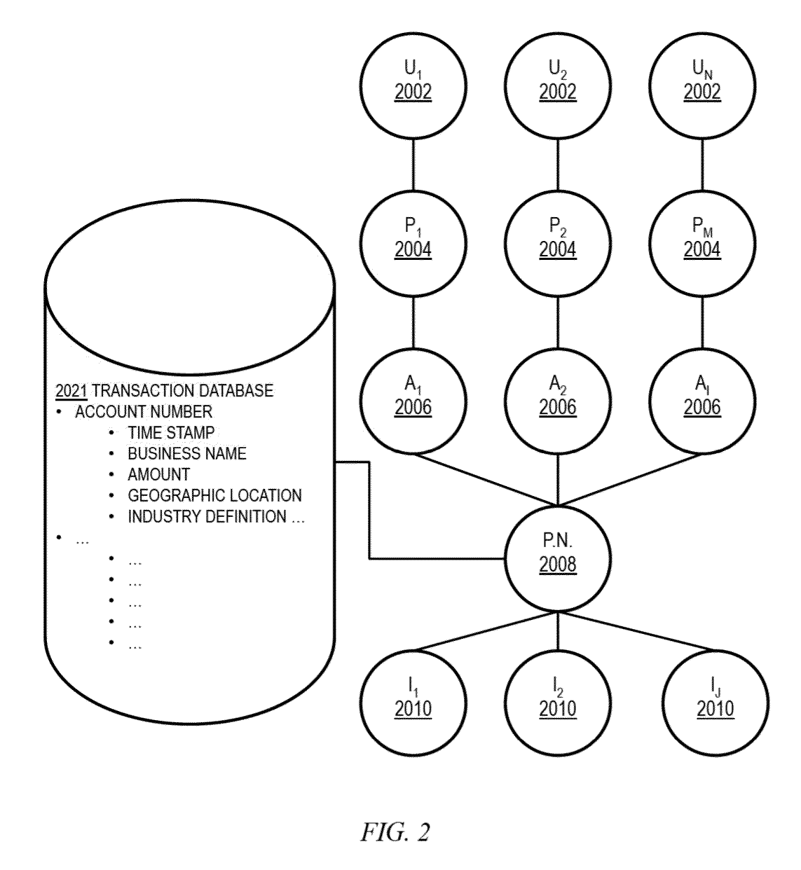

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards, e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN), such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as reader module 132 that is coupled to the processor and configured to interface with the portable apparatuses 102, 112, 150. The processor 130 can be operable to communicate with portable payment devices of a user via the reader module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification from a UPC code or RFID tag on a product to be purchased.

The above-described devices 102, 112 can be International Organization for Standardization (ISO) 7816-compliant contact cards or devices or NFC (Near Field Communications) or ISO 14443-compliant proximity cards or devices. In operation, card 112 can be touched or tapped on the wireless terminal 124 or reader module 132 (or an associated reader), which then contactlessly transmits the electronic data to the proximity IC chip in the card 112 or other wireless device.

One or more of the processing centers 140, 142, 144 can include a database such as a data warehouse 154.

It should be noted that the system depicted in FIG. 1 may involve not only conventional transactions at “brick and mortar” merchants, but also, e.g., e-commerce, such as card-not-present Internet transactions. In some instances, an Internet Protocol (IP) address may be captured during such a transaction. In some instances, data from such card-not-present Internet transactions can be used, for example, to infer a cardholder's home address. In some cases, an individual utilizes his or her home computer to communicate with a server of an e-commerce merchant over the Internet. The individual provides his or her PAN to the merchant's server. The merchant utilizes the PAN to initiate an authorization request, and upon receiving an authorization request response indicating approval, will complete the e-commerce transaction.

In some cases, there can be payment card accounts that do not have physical cards or other physical payment devices associated therewith; for example, a customer can be provided with a PAN, expiration date, and security code, but no physical payment device, and use same, for example, for card-not-present telephone or internet transactions. Transaction data for such accounts is also pertinent in one or more embodiments.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . Iⱼ, through, for example, a single operator of a payment network 2008 configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the consumer 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the payment network 2008, which debits the issuers 2010 for payment and credits the acquirer 2006. Once the acquirer 2006 has been paid, the acquirer 2006 pays the merchant 2004.

Transaction database 2021 is discussed below.

It will be appreciated that the payment network 2008 shown in FIG. 2 is an example of a payment network configured to facilitate transactions between multiple issuers and multiple acquirers, which may be thought of as an “open” system. Some embodiments of the disclosure may be employed with other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the ISO Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of payment card transactions such as for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN) (which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. Nos. 6,636,833 and 7,136,835 of Flitcroft et al., the complete disclosures of both of which are expressly incorporated herein by reference in their entireties for all purposes. It is worth noting that in one or more embodiments, single use PANS are only valuable to the extent that they can be re-mapped to the underlying account, cardholder, or household. In one or more embodiments of the disclosure, a PAN or other payment card account number represents an individual; this also leads to useful insight once aggregated to a higher level.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network.

One or more embodiments of the disclosure provide a “Health Index” based on spending patterns, which can be used, for example, for social and/or marketing purposes. Of course, embodiments are intended to be used in full compliance with all applicable laws, regulations, policies, and procedures protecting privacy rights.

In one or more embodiments of the disclosure, existing credit card (or other payment card) transactional data for each card member is used to determine a customer's degree of health consciousness. In some cases, this degree is relative; for example, based on comparison to a national average (or an average for some other geographical or political area). One example of payment card transactional data is that in transaction database 2021, to be discussed further below.

The transactional data can be used for various purposes, across different time periods, as well as different geographies; for example, for marketing and/or social usage. In one or more embodiments, to avoid data privacy concerns, the focus is on subjective “healthier” merchants and gym clubs (that is to say, focus on transactional behavior, i.e., lifestyle type clues about health, as opposed to data from actual healthcare-related merchants and/or industries, such as physicians, pharmacies, hospitals, and the like). Furthermore in this regard, all embodiments should comply fully with applicable laws, rules, regulations, policies and procedures designed to protect the security and privacy of health data (for example, in the U.S., The Health Insurance Portability and Accountability Act of 1996 (HIPAA; Pub.L. 104-191, 110 Stat. 1936, enacted Aug. 21, 1996)). In one or more embodiments, such data is expressly excluded from analysis, so that this specific issue does not arise. Again, in any case, embodiments are intended to be used in full compliance with all applicable laws, regulations, policies, and procedures protecting privacy rights.

In one or more embodiments of the disclosure, define average spend and location of spend in the three following categories:
1. Standard “Mass Food Consumption” Consumers—fast food restaurant chains, big chain supermarkets, bakeries, donut stores, and the like
2. “Healthier” Merchants—supermarkets or other stores featuring healthy, natural, and/or organic foods; juice bars; optionally stores selling vitamins and/or other supplements
3. Exercise consciousness—Gym memberships (excluding spas, i.e., excluding places geared towards beauty and/or appearance as opposed to exercise, fitness, or training), sporting goods stores

Note that other embodiments of the disclosure could utilize alternative categories. For example, some embodiments of the disclosure could treat stores selling vitamins and/or other supplements as a separate category from other “healthier” merchants.

The merchants in each category can be determined, for example, by business names and/or by a predefined industry definition (e.g., merchant category code (MCC)). Referring now to transaction database 2021, in one or more embodiments of the disclosure, the same includes a plurality of records for a plurality of different account numbers (PANs) for a single brand of payment card products, MASTERCARD cards being a non-limiting example. Each PAN typically has a plurality of different transactions; the record for each transaction may include, for example, a time stamp, the amount, and some type of identification for the merchant, such as business name and/or predefined industry definition, as discussed just above. The ellipses indicate that each PAN has many transactions, and that there are many PANs. In one or more embodiments, the geographic location of the merchant and/or the geographic location of the customer have relevance. In some instances, the assumption is made that an urban population will behave differently then a rural and/or suburban population. Transactions in database 2021 typically include some indicia of the merchant location. In some instances, it is also desired to estimate the residential location (e.g., zip or other postal code) of the cardholder. In some embodiments of the disclosure, this can simply be approximated as the location (e.g., zip or other postal code) of the merchant, since people are assumed to visit brick and mortar locations fairly close to where they live. This approach may be particularly appropriate when data is aggregated for groups of cardholders.

In some embodiments of the disclosure, the cardholder's residential zip code can be inferred using methods disclosed in unpublished U.S. patent application Ser. No. 13/721,216 of first named inventor Curtis Villars, filed Dec. 20, 2012 and entitled METHOD AND SYSTEM FOR ASSIGNING SPENDING BEHAVIORS TO GEOGRAPHIC AREAS. The Villars reference is hereby expressly incorporated by reference herein in its entirety for all purposes and pertinent portions are reproduced below (figure and reference characters are changed as needed to avoid confusion with those of the present disclosure). Furthermore in this regard, residential zip code can be inferred by the centroid of transactions likely to be carried out near home; work zip code can be inferred by the centroid of transactions likely to be carried out near work. Again, zip code is a non-limiting example of a postal code or other similar geographic indicia.

As noted, transaction database 2021, in one or more embodiments of the disclosure, includes a plurality of records for a plurality of different account numbers (PANs) for a single brand of payment card products, MASTERCARD cards being a non-limiting example. More specifically, in at least some embodiments of the disclosure, raw data in database 2021 includes a single record for each transaction. As will be discussed further below, tables can be constructed by data mining or other querying against the PAN to obtain a table with all the transactions for a given PAN in a given time period. Further tables can be constructed; for example, within a table for a given PAN in a given time period, queries can be run to determine all the spending in a given industry.

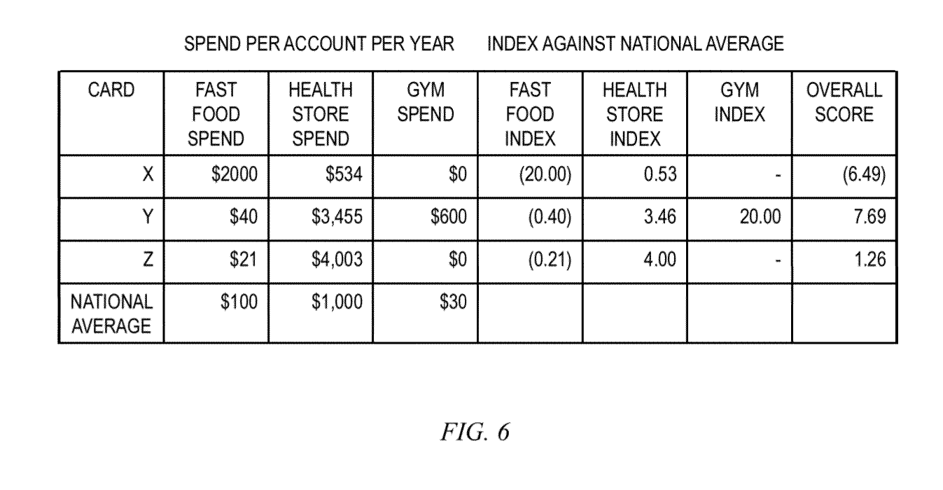

In one or more embodiments of the disclosure, the defined national aggregated spend in the above-listed three categories is compared against each individual's spend in the same categories. An index is created in each of the three categories for each customer. Referring now to FIG. 6, once the three indices are calculated, a score can be derived from the indices using various methods. Each card then has a score that reflects the transactional behavior in the three categories. A bottom-most group of low-scoring individuals can be designated as “At Risk for Health.” Conversely, the top-most scoring group of the population can be designated as “Healthy.” In the non-limiting example of FIG. 6, there are three card accounts, each of which would typically have a unique PAN; for convenience, these three accounts are simply designated as X, Y, and Z. Category 1 above is designated in FIG. 6 by the shorthand “FAST FOOD SPEND.” Card X has $2000 of spending in this category, Card Y has $40 of spending in this category, and Card Z has $21 of spending in this category. The national average for this category is $100. In the non-limiting example of FIG. 6, the spending amounts are for a one-year period. Category 2 above is designated in FIG. 6 by the shorthand “HEALTH STORE SPEND.” Card X has $534 of spending in this category, Card Y has $3,455 of spending in this category, and Card Z has $4,003 of spending in this category. The national average for this category is $1,000. Category 3 above is designated in FIG. 6 by the shorthand “GYM SPEND.” Card X has $0 of spending in this category, Card Y has $600 of spending in this category, and Card Z has $0 of spending in this category. The national average for this category is $30.

An index can be calculated against a national average (or other average or parameter) for each category for each card account, and an overall score can be ascertained for each card account. The “Fast Food Index” for card account X is calculated as 20.00 by dividing the fast food spend of $2000 for card account X by the national average of $100. The numbers in the fast food index are enclosed in parentheses to symbolize negative values; i.e., belief that excessive fast food consumption detracts from overall health. The health store and gym indexes are positive numbers reflecting the belief that healthy eating and exercise add to overall health. The “Fast Food Index” for card account Y is calculated as 0.40 by dividing the fast food spend of $40 for card account Y by the national average of $100. The “Fast Food Index” for card account Z is calculated as 0.21 by dividing the fast food spend of $21 for card account Z by the national average of $100.

The “Health Store Index” for card account X is calculated as 0.53 by dividing the health store spend of $534 for card account X by the national average of $1,000. The “Health Store Index” for card account Y is calculated as 3.46 by dividing the health store spend of $3,455 for card account Y by the national average of $1,000. The “Health Store Index” for card account Z is calculated as 4.00 by dividing the health store spend of $4,003 for card account Z by the national average of $1,000.

The “Gym Index” for card account X is calculated as 0 (indicated by the dash “-”) by dividing the gym spend of $0 for card account X by the national average of $30. The “Gym Index” for card account Y is calculated as 20.00 by dividing the gym spend of $600 for card account Y by the national average of $30. The “Gym Index” for card account Z is calculated as 0 (indicated by the dash “-”) by dividing the gym spend of $0 for card account Z by the national average of $30.

In a non-limiting example, the overall score is calculated for each of the cards X, Y, and Z as the average of the three index scores, where the higher the score, the more healthy a cardholder is considered to be. Still referring to FIG. 6, Card X has an overall score of (−20+0.53+0)/3=−6.49; Card Y has an overall score of (−0.4+3.446+20)/3=7.69; and Card Z has an overall score of (−0.21+4+0)/3=1.26.

In a non-limiting specific example, index each card account (e.g., via PAN, as a proxy for customer) against the average spend within each category. Create deciles (or other pre-determined number of appropriate subdivisions) based on the index for each category. For the top decile (or other appropriate subdivision) in the “FAST FOOD” category and lowest decile (or other appropriate subdivision) in the other, healthy categories, set up a proxy to designate this group as “At Risk for Health.” On the other hand, for the top decile (or other appropriate subdivision) in the other, healthy categories and the lowest decile (or other appropriate subdivision) in the “FAST FOOD” category, set up a proxy to designate this group as “Healthy.”

In one or more embodiments of the disclosure, individual indexes and/or overall scores can be tracked over time to determine the existence of one or more correlations against existing health time series data. This information can also be useful for marketing of health and/or exercise companies. Furthermore, the data can be segmented by geographic region to reflect regional disparities from the national norm, and/or can be further segmented based on geospatial divisions. The data can also be used for social analysis for public health awareness.

Thus, by way of review and provision of additional detail, one or more embodiments mine transaction data to create a healthiness index. This index is a subjective view of a person's health. In one or more embodiments, a determination is made regarding what the person spends in the three predetermined categories set forth above. Again, as noted, other embodiments of the disclosure could utilize alternative categories, such as treating stores selling vitamins and/or other supplements as a separate category from other “healthier” merchants.

All of the purchase behaviors in the predetermined categories are aggregated (for example, to a yearly level), and then are compared with national (or other) baseline behavior for the categories. Each card or customer is provided with an index of how he or she behaves in the categories as compared to the national (or other) baseline. The scores from the indexes are combined via multiplication or summation. Once there is an index of the individuals, the index can be divided into deciles or other predetermined groupings, using appropriate statistical methods. In some instances, those who score high on health and low on fast food can be considered as healthy. In some instances, those who eat frequently at fast food restaurants and score low in the healthy categories can be categorized as at-risk.

It will be appreciated that categories 1-3 generally correspond to, respectively, an indication of unhealthy food and drink consumption, an indication of healthy food and drink consumption, and an indication of propensity to exercise. The skilled artisan, given the teachings herein, will be able to select what types of merchants belong in each category in a given locale. For example, a “big chain” supermarket that actively targets consumers to encourage purchase of fruits, vegetables, and the like may not belong in the first category, but rather, may belong in the second category, or may offer both healthy and unhealthy food choices and may not be an accurate predictor.

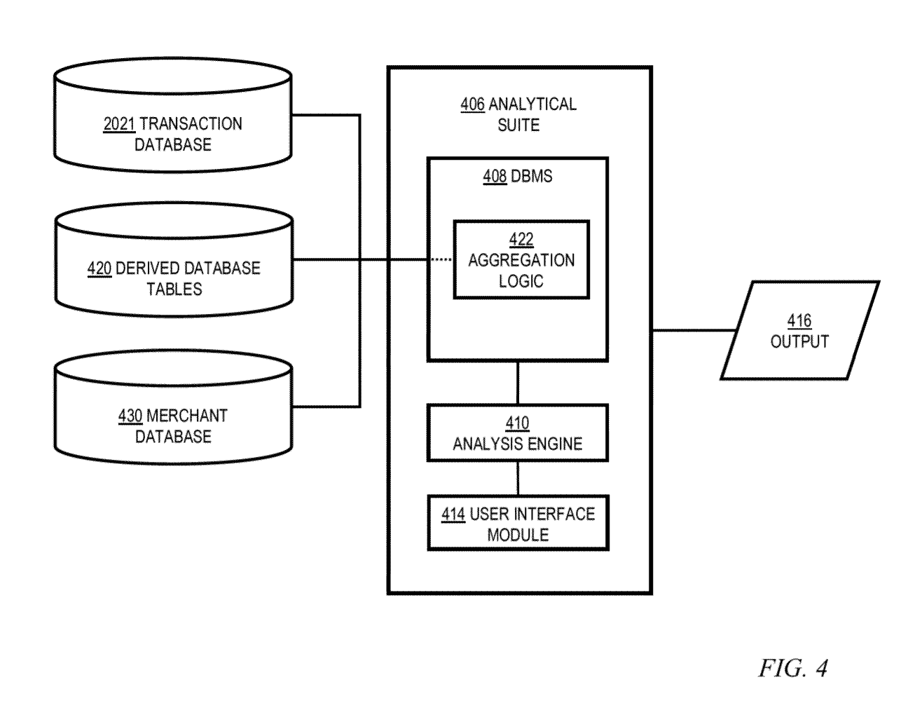

Referring to FIG. 4, in one or more embodiments, a suitable database management system (DBMS) 408 is provided (e.g., as part of an analytical suite 406) for querying the derived database tables 420 and merchant data stored in the merchant database 430. In one specific non-limiting example, DBMS 408 includes aggregation logic 422 that queries “raw” transaction data in transaction database 2021 and creates one or more derived database tables 420, which are then further queried by DBMS 408. In a non-limiting example, databases 420 and 2021 are queried using structured query language (SQL). In one or more embodiments, suite 406 also includes an analysis engine 410 and a user interface module 414. One suitable software program is the SAS software suite available from SAS Institute, Cary, N.C., USA. Suite 406 provides output at 416. Reference is also made to the discussion of Netezza appliances and applications, and structured query language (SQL) below.

To determine what merchants to track and what categories they belong in, well-known MCC codes or payment card network-operator pre-defined merchant-industry relationships can be employed; e.g., from merchant database 430.

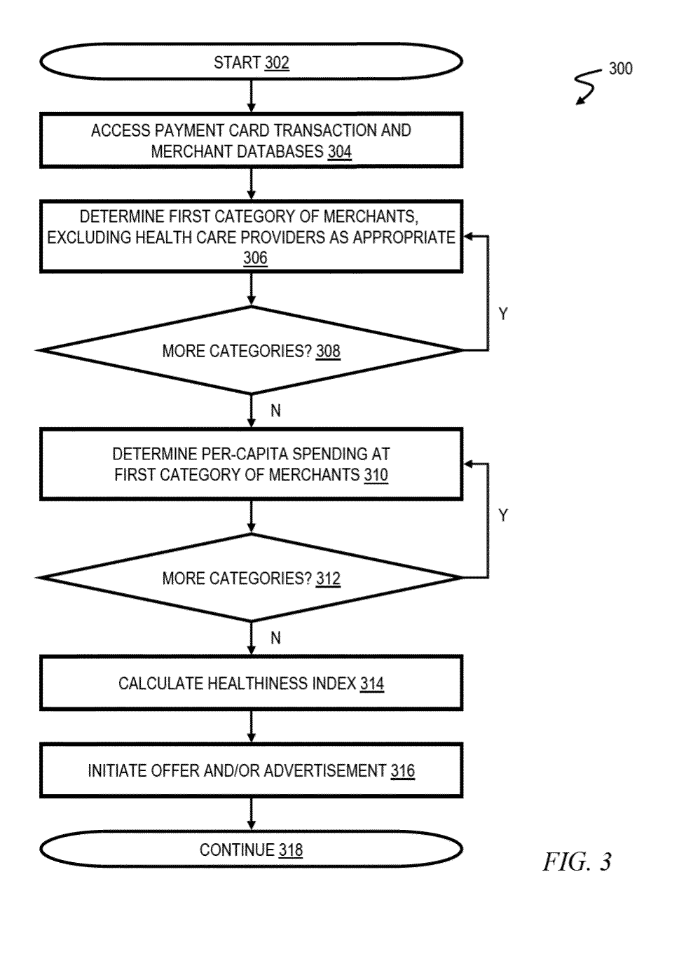

Referring now to flow chart 300 of FIG. 3, which begins in step 302, it will be appreciated that in one or more embodiments, access is obtained to a database of transaction data 2021 and/or derived database tables 420, as well as to a database or merchant data 430, as shown in step 304. The transaction data includes data for transactions carried out with a payment card network. The transactions can be in-person transactions at a brick-and-mortar merchant, or card-not-present Internet transactions. The payment card network can utilize, for example, a three-party model or a four-party model.

In optional step 306, in one or more embodiments, a determination is made regarding which merchants having transaction data in database 2021 have a potential correlation with cardholder health. The correlation can be positive (e.g., health food stores, gyms) or negative (e.g., fast food stores, stores catering to smokers). Some merchants may not have any correlation to cardholder health (e.g., merchants selling dress clothing). As noted, the merchants can be identified by business names and/or by a predefined industry definition (e.g., merchant category code (MCC)). The merchants are assigned to categories, such as categories 1-3 discussed above. As indicated in optional decision block 308, optional step 306 is repeated until all the desired categories are complete. In other embodiments, the information regarding merchants having transaction data in database 2021 that also have a potential correlation with cardholder health is obtained as a given instead of as the result of carrying out steps 306 and 308.

One or more payment card accounts are identified for analysis. For each payment card account that is to be analyzed, the total per capita spending is determined for each of the categories for a predetermined time, as shown in step 310; decision block 312 indicates that step 310 is repeated until all the desired categories are complete. This can be done, for example, by querying database 2021 and/or derived database tables 420 with DBMS 408. For example, a query is run for entries in database 2021 and/or derived database tables 420 for the PAN corresponding to the account to be analyzed, with time stamps falling within the range of interest (e.g., Jan. 1, 2015-Dec. 31, 2015), and where the business name and/or MCC matches a list of business names and/or MCCs associated with the first category of interest. The amounts for each of these transactions are summed using, e.g., analysis engine 410, to obtain total spending in the first category of interest. Another query is run for entries in database 2021 and/or derived database tables 420 for the PAN corresponding to the account to be analyzed, with time stamps falling within the range of interest (e.g., Jan. 1, 2015-Dec. 31, 2015), and where the business name and/or MCC matches a list of business names and/or MCCs associated with the second category of interest. The amounts for each of these transactions are summed using, e.g., analysis engine 410, to obtain total spending in the second category of interest. This is repeated for any additional categories, as shown in decision block 312, as discussed above.

In some cases, the total spending in each category of interest for the given PAN is compared to a baseline value for each category, and this comparison is used to develop an overall score for the cardholder associated with the given PAN, as shown in step 314. In some cases, as discussed in the example above, the baseline value is a national average (or average for some other region or group of interest), and the comparison includes dividing the score for the PAN of interest in a given category by the baseline (typically, per capita) in that category. The comparison can be carried out, for example, with analysis engine 410.

Other techniques can be used to calculate the overall score besides a “straight” average; e.g., a weighted average wherein indices believed to be more significant are weighted higher. For example, if the “gym index” was believed to be a stronger predictor than the “fast food index” and the “health store index” it could be given an empirically higher weight in the averaging process in the overall score calculation.

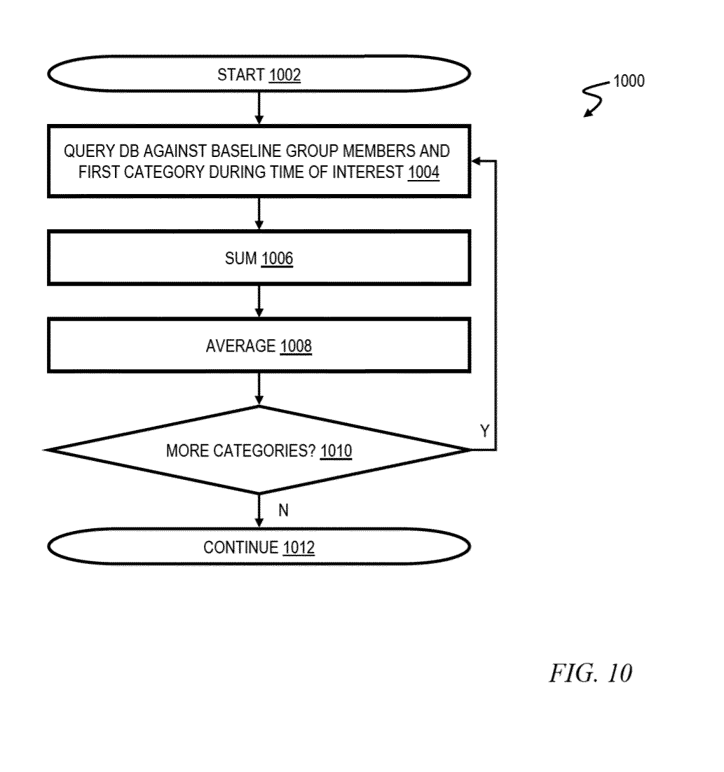

In some cases, as shown in flow chart 1000 of FIG. 10, which begins in step 1002, to determine the baseline, database 2021 and/or derived database tables 420 are queried with DBMS 408, as in step 1004. For example, a query is run for entries in database 2021 and/or derived database tables 420 for all PANs corresponding to the baseline region or group, with time stamps falling within the range of interest (e.g., Jan. 1, 2015-Dec. 31, 2015), and where the business name and/or MCC matches a list of business names and/or MCCs associated with the first category of interest. The amounts for each of these transactions are summed using, e.g., analysis engine 410, to obtain baseline spending in the first category of interest, as shown at step 1006. As shown in step 1008, the total baseline spending in the first category of interest can be divided by the number of PANs associated with the baseline region or group to approximate an average per capita baseline spending amount. The number of PANs associated with the baseline region or group can be determined, for example, by querying the database 2021 and/or derived database tables 420 within the population of interest and summing the number of individual accounts; the sum itself can be stored, for example, in a derived database table in derived database tables 420).

Another query is run for entries in database 2021 and/or derived database tables 420 for all PANs corresponding to the baseline region or group, with time stamps falling within the range of interest (e.g., Jan. 1, 2015-Dec. 31, 2015), and where the business name and/or MCC matches a list of business names and/or MCCs associated with the second category of interest. The repetition for multiple categories is shown in decision block 1010. The amounts for each of these transactions are summed using, e.g., analysis engine 410, to obtain baseline spending in the second category of interest. Step 1008 is repeated as well. This process is repeated for any additional categories.

In an alternative approach, step 1008 can be performed after the sum 1006 has been calculated for each category, i.e., after step 1010.

Processing continues in step 1012.

The overall score for each given PAN can be used in a variety of ways. In this regard, it is worth noting that in some cases, the records in database 2021 do not include any information that allows for identifying the cardholder associated with the PAN, and/or contractual or other obligations do not permit access or use of such information. In such cases, the issuing bank typically has this information. Thus, in at least some cases, an operator of a payment network, such as payment network 2008, offers a service to the issuer, who makes the health score available to the actual cardholder. Note, however, that this is a non-limiting example. In other instances for example, in cases of cardholder opt-in or other form of cardholder consent, it is permissible to link the records in database 2021 with data identifying the cardholder associated with the PAN. In some embodiments, where available, linkage to a specific cardholder is stored in derived database tables 420. In some instances, the score can be used to identify individuals who might be fruitful targets for marketing of exercise and/or healthy foods, e.g., individuals with poor scores who need to start exercising and/or eating right, who might be given introductory offers, and/or individuals with good scores who already exercise and/or eat right, who might be given offers to induce them to transfer over to a new gym or different health food store. Step 316 depicts exemplary use of the results. Processing continues in step 318.

In some cases, scoring is carried out for different demographic groups or geographical or political regions (all referred to for convenience as a “group to be analyzed”). In some instances, this is done by averaging the scores for the individual PANs associated with those demographic groups or geographical or political regions. In some instances, techniques of the aforementioned Villars reference can be used to link a zip (or other postal) code to a PAN (or other payment card account number) to infer geospatial location. On the other hand, in some instances, where group-related data is desired, scores for individual PANs need not necessarily be determined. Instead, for each group that is to be analyzed, the total spending is determined for each of the categories for a predetermined time. This can be done, for example, by querying database 2021 and/or derived database tables 420 with DBMS 408. For example, a query is run for entries in database 2021 and/or derived database tables 420 for the PANs corresponding to the group to be analyzed, with time stamps falling within the range of interest (e.g., Jan. 1, 2015-Dec. 31, 2015), and where the business name and/or MCC matches a list of business names and/or MCCs associated with the first category of interest. The PAN(s) corresponding to the group to be analyzed can be selected and scored by any suitable technique, for example, either the complete population or a subset based on any type of filter (e.g., geographical, spending category, spending amount, or the like).

The amounts for each of the transactions are summed using, e.g., analysis engine 410, to obtain total spending in the first category of interest. Another query is run for entries in database 2021 and/or derived database tables 420 for the PANs corresponding to the group to be analyzed, with time stamps falling within the range of interest (e.g., Jan. 1, 2015-Dec. 31, 2015), and where the business name and/or MCC matches a list of business names and/or MCCs associated with the second category of interest. The amounts for each of these transactions are summed using, e.g., analysis engine 410, to obtain total spending in the second category of interest. This is repeated for any additional categories. The total spending in each category can be divided by the number of PANs to approximate an average per capita spending amount for the group of interest.

In some cases, the average per capita spending in each category of interest for the given group to be analyzed is compared to a baseline value for each category, and this comparison is used to develop an overall score for the group to be analyzed. In some cases, as discussed in the example above, the baseline value is a national average (or average for some other region or group of interest), and the comparison includes dividing the score for the group to be analyzed in a given category by the baseline (typically, per capita) in that category. The comparison can be carried out, for example, with analysis engine 410.

The overall score for the group to be analyzed can be used in a variety of ways. In some instances, the score can be used to identify groups who might be fruitful targets for marketing of exercise and/or healthy foods, e.g., groups with poor scores who need to start exercising and/or eating right might be given introductory offers, and/or groups with good scores who already exercise and/or eat right might be given offers to induce them to transfer over to a new gym or different health food store. Furthermore, in some instances, the overall score for the group to be analyzed can be used for social (e.g., public health) purposes. For example, governmental authorities may target public service advertisements encouraging healthy eating and/or exercise towards regions of the country and/or demographic groups with poor scores.

### Recapitulation and Per-Capita Spending Determination Examples

Given the discussion thus far, and referring again to FIGS. 3 and 4, it will be appreciated that, in general terms, an exemplary method, according to an aspect of the disclosure, includes the step 304 of accessing a database 2021 and/or 420 of payment card transaction data and a database of merchant data 430. This step can be carried out, for example, by using DBMS 408 to query databases 2021, 420, and/or 430. As noted, in some instances, aggregation logic 422 of DBMS 408 queries raw data 2021 to produce derived database tables 420 for further querying and/or analysis by DBMS 408 and analysis engine 410, respectively. Merchant database 430 can include, for example, a merchant-industry look-up table with a pre-defined industry for each of the relevant merchants (pre-defined, e.g., by the operator of the payment network 2008).

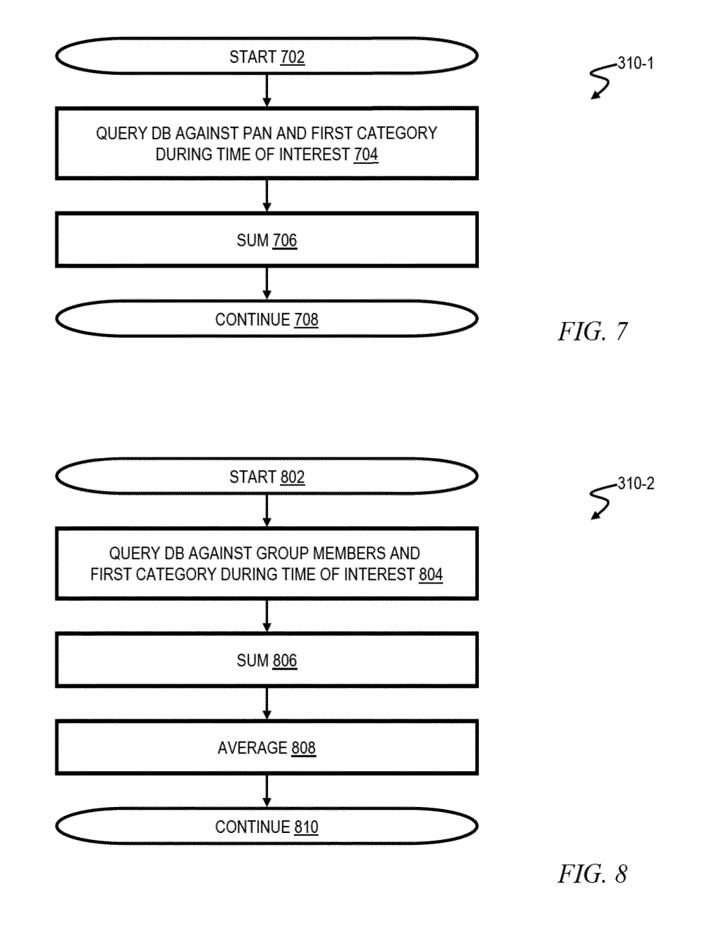

An additional step 310 includes determining per-capita spending at a first plurality of merchants for at least one payment card account for a predetermined time period. The first plurality of merchants have transaction data in the derived database tables 420 and/or transaction database 2021 of payment card transaction data. Patronizing the first plurality of merchants is associated with good cardholder health. FIGS. 7-9, discussed below, provide non-limiting examples of how to determine per-capita spending.

Step 310 is repeated for at least a second plurality of merchants, as per the decision block 312. Thus, a further step includes determining per-capita spending at a second plurality of merchants for the at least one payment card account for the predetermined time period. The second plurality of merchants have transaction data in the database of payment card transaction data. Patronizing the second plurality of merchants is associated with bad cardholder health. Again, FIGS. 7-9, discussed below, provide non-limiting examples of how to determine per-capita spending.

Step 310 can be carried out, for example, by the database management system module 408 (optionally using the aggregation logic 422) and the analysis engine 410.

It will be appreciated that the first and second pluralities of merchants represent, respectively, first and second categories of merchants.

An even further step 314 includes determining an overall healthiness index score for the at least one payment card account for the predetermined time period, based on comparison of the determined per-capita spending at the first plurality of merchants for the at least one payment card account for the predetermined time period and the determined per-capita spending at the second plurality of merchants for the at least one payment card account for the predetermined time period to respective baseline values. Refer to the discussion of FIG. 6 for non-limiting examples. This step can be carried out, for example, with analysis engine 410.

As noted above, in one or more embodiments, the first and second pluralities (categories) or merchants are taken as a given, having been determined beforehand by human subject matter experts. However, optionally, the method can include step 306, determining the first plurality of merchants having transaction data in the database of payment card transaction data, which can be repeated as needed, e.g., determining a second plurality of merchants having transaction data in the database of payment card transaction data.

The overall healthiness index score can be determined for one PAN or for groups of PANs. In the former case, step 310, determining the per-capita spending at the first plurality of merchants, for the payment card account, for the predetermined time period can be carried out as shown in flow chart 310-1 of FIG. 7, which begins at step 702. Step 704 includes querying the database 2021, 420 for transactions for a single primary account number (PAN) at the first plurality of merchants during the predetermined time period. This can be carried out, for example, by using DBMS 408 to query database 2021 or 420; in a non-limiting example, aggregation logic 422 queries database 2021 and creates a table in database 420 with the results. Step 706 includes summing amounts of the transactions for the single primary account number (PAN) at the first plurality of merchants during the predetermined time period. This can be carried out, for example, by using analysis engine 410. The process is continued as needed; thus, the per-capita spending at the second plurality of merchants for the at least one payment card account for the predetermined time period is determined by repeating step 704 by querying the database 2021, 420 for transactions for the single primary account number (PAN) at the second plurality of merchants during the predetermined time period. Again, this can be carried out, for example, by using DBMS 408 to query database 2021 or 420; in a non-limiting example, aggregation logic 422 queries database 2021 and creates a table in database 420 with the results. Repeated step 706 includes summing amounts of the transactions for the single primary account number (PAN) at the second plurality of merchants during the predetermined time period. Again, this can be carried out, for example, by using analysis engine 410. Processing continues at step 708.

Returning again to FIG. 3, when the overall healthiness index score has been determined for one PAN at step 314, optional step 316 can include initiating a health-related offer to a cardholder associated with the single primary account number (PAN), based on the overall healthiness index score. This can be done, for example, through the issuer of the cardholder's card account and/or through the merchant.

Overall healthiness index scores for groups of PANs can be determined in a number of different ways. Refer to flow chart 310-2 of FIG. 8, which begins at 802. In one aspect, step 310, determining of the per-capita spending at the first plurality of merchants for the at least one (in this case, more than one) payment card account for the predetermined time period includes the steps in FIG. 8. In step 804, query the database 2021 and/or 420 for transactions for a group to be analyzed at the first plurality of merchants during the predetermined time period. This can be carried out, for example, by using DBMS 408 to query database 2021 or 420; in a non-limiting example, aggregation logic 422 queries database 2021 and creates a table in database 420 with the results. Step 806 includes summing amounts of the transactions for the group to be analyzed at the first plurality of merchants during the predetermined time period. This can be carried out, for example, by using analysis engine 410. Step 808 includes taking an average; e.g., dividing the summed amounts of the transactions for the group to be analyzed at the first plurality of merchants during the predetermined time period by the number of members of the group, to obtain the per-capita spending at the first plurality of merchants. This can be carried out, for example, by using analysis engine 410.

The process is continued as needed; thus, the per-capita spending at the second plurality of merchants for the at least one payment card account for the predetermined time period is determined by repeating step 804, querying the database 2021 and/or 420 for transactions for the group to be analyzed at the second plurality of merchants during the predetermined time period. Again, this can be carried out, for example, by using DBMS 408 to query database 2021 or 420; in a non-limiting example, aggregation logic 422 queries database 2021 and creates a table in database 420 with the results. Repeated step 806 includes summing amounts of the transactions for the group to be analyzed at the second plurality of merchants during the predetermined time period. Again, this can be carried out, for example, by using analysis engine 410. Repeated averaging step 808 includes, e.g., dividing the summed amounts of the transactions for the group to be analyzed at the second plurality of merchants during the predetermined time period by the number of members of the group to obtain the per-capita spending at the second plurality of merchants. Once again, this can be carried out, for example, by using analysis engine 410. Processing continues at step 810.

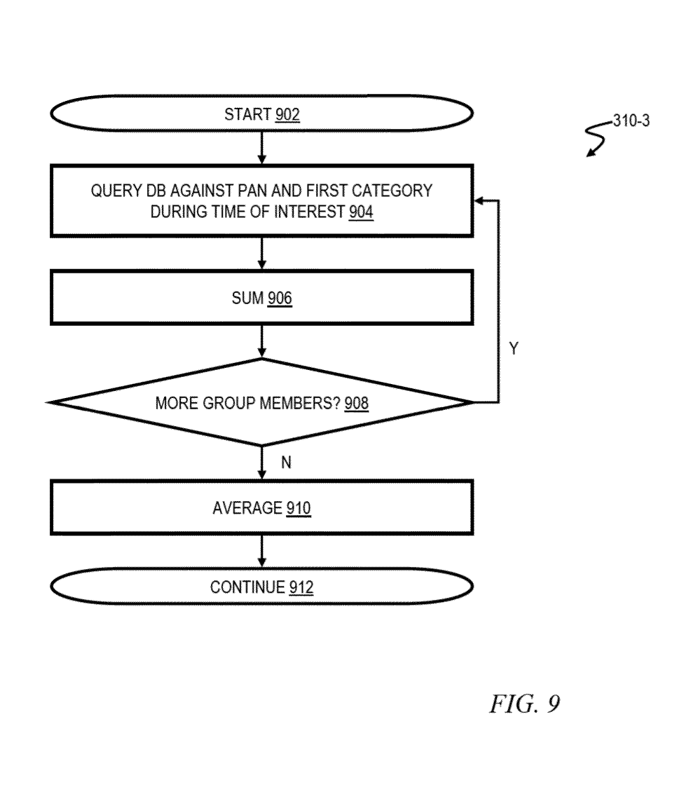

As noted, overall healthiness index scores for groups of PANs can be determined in a number of different ways. Refer to flow chart 310-3 of FIG. 9, which begins at 902. In one aspect, step 310, determining of the per-capita spending at the first plurality of merchants for the at least one payment card account for the predetermined time period includes steps shown in FIG. 9. Step 904 includes querying the database 2021 and/or 420 for transactions for a single primary account number (PAN) at the first plurality of merchants during the predetermined time period. This can be carried out, for example, by using DBMS 408 to query database 2021 or 420; in a non-limiting example, aggregation logic 422 queries database 2021 and creates a table in database 420 with the results. Step 906 includes summing amounts of the transactions for the single primary account number (PAN) at the first plurality of merchants during the predetermined time period. This step can be carried out, for example, by using analysis engine 410. As indicated by decision block 908, the querying and summing steps 904, 906 are repeated for the first plurality of merchants during the predetermined time period such that the querying and summing steps are carried out for multiple primary account numbers (PANs). The logic in decision block 908 can be included, for example, in analysis engine 410. Step 910 includes averaging results obtained for the multiple primary account numbers (PANs) to obtain the per-capita spending at the first plurality of merchants for the at least one payment card account for the predetermined time period. Once again, this can be carried out, for example, by using analysis engine 410.

The process is continued as needed; thus, determining the per-capita spending at the second plurality of merchants for the at least one payment card account for the predetermined time period includes repeated step 904, querying the database for transactions for a single primary account number (PAN) at the second plurality of merchants during the predetermined time period; repeated step 906, summing amounts of the transactions for the single primary account number (PAN) at the second plurality of merchants during the predetermined time period; under control of decision block 908, again repeating the querying and summing steps 904, 906 for the second plurality of merchants during the predetermined time period such that the querying and summing steps are carried out for the multiple primary account numbers (PANs); and repeated step 910, averaging results obtained for the multiple primary account numbers (PANs) to obtain the per-capita spending at the second plurality of merchants for the at least one payment card account for the predetermined time period. The repeated steps can be carried out using the same hardware and software components as described for the initial steps.

Processing continues at step 912.

Returning again to FIG. 3, when the overall healthiness index score has been determined for a group of PANs, optional step 316 can include initiating a health-related advertisement to cardholders associated with the group to be analyzed, based on the overall healthiness index score. In this regard, when a single PAN is analyzed, the overall healthiness index score is for that PAN, while, when a group of PANs are analyzed, the overall healthiness index score is for the group. This can be done, for example, through the issuers of the cardholder's card accounts and/or through one or more merchants.

Referring again to FIG. 3, as indicated by decision blocks 308 and 312, as many categories of merchants as desired can be analyzed. For example, in embodiments employing the three specific categories discussed above, a third plurality of merchants having transaction data in the database of payment card transaction data may be obtained as a given or determined in repeated step 306. Patronizing the third plurality of merchants is associated with good cardholder health. Repeated step 310 includes determining per-capita spending at the third plurality of merchants for the at least one payment card account for the predetermined time period. The overall healthiness index score for the at least one payment card account for the predetermined time period is further based on comparison of the determined per-capita spending at the third plurality of merchants for the at least one payment card account for the predetermined time period to a respective baseline value. The first plurality of merchants includes merchants associated with healthy eating; the second plurality of merchants includes merchants associated with unhealthy eating; and the third plurality of merchants includes merchants associated with exercise.

As noted above, one or more embodiments infer health from transactions with merchants other than actual health care providers. Thus, one or more embodiments include the additional step of excluding health care providers from the first and second (and any additional) pluralities of merchants. This can be done, for example, by blocking MCCs or merchant identities known to be doctors, dentists or pharmacies when querying with DBMS 408 and/or aggregation logic 422 thereof.

Referring again to flow chart 1000 of FIG. 10, in order to calculate the baseline, one or more embodiments include the steps of FIG. 10. In step 1004, query the database 2021 or 420 for transactions for a baseline group at the first plurality of merchants during the predetermined time period. This can be carried out, for example, by using DBMS 408 to query database 2021 or 420; in a non-limiting example, aggregation logic 422 queries database 2021 and creates a table in database 420 with the results. In step 1006, sum amounts of the transactions for the baseline group at the first plurality of merchants during the predetermined time period. This can be carried out, for example, by using analysis engine 410. In step 1008, take an average; for example, by dividing the summed amounts of the transactions for the baseline group at the first plurality of merchants during the predetermined time period by the number of members of the baseline group to obtain the first one of the respective baseline values. As indicated by decision block 1010, repeat steps 1004-1008 for all the categories of interest.

As note, the overall score can be calculated in a number of different ways. In one or more embodiments, the determining of the overall healthiness index score for the at least one payment card account for the predetermined time period includes (again referring to the example of FIG. 6) dividing the determined per-capita spending at the first plurality of merchants for the at least one payment card account by a first of the respective baseline values to obtain a first partial index; annexing a negative sign (fast food index in parentheses to indicate negative effects on health, e.g.) to the determined per-capita spending at the second plurality of merchants for the at least one payment card account and dividing same by a second of the respective baseline values to obtain a second partial index; and taking an average (weighted or simple) of the first and second partial indices to obtain the overall healthiness index score for the at least one payment card account for the predetermined time period.

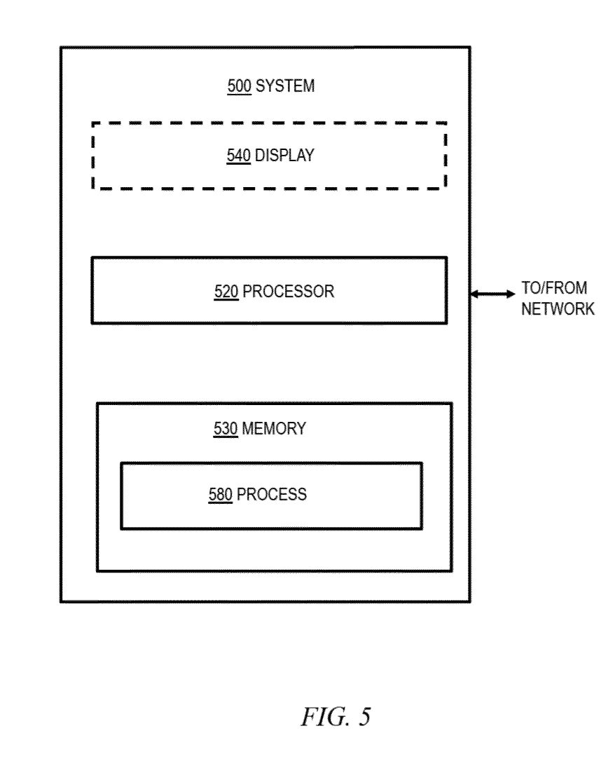

As noted, in some cases, an exemplary apparatus includes means for carrying the method steps described herein. The means can include, for example, the components of FIG. 4 implemented on one or more general purpose computers 500, as discussed below with respect to FIG. 5. The specific algorithm(s) include(s), for example, the specific queries, calculations, and decision block logic set forth herein.

SQL or Structured Query Language is a special-purpose programming language designed for managing data held in a relational database management system (RDMS). SQL and RDMS are non-limiting examples of suitable query techniques and database management systems, respectively.

Means for making results available to at least one or more appropriate parties include a user interface module 414, optionally producing output 416. The module can include, in some cases, an application program interface (API) when one or more techniques disclosed herein are offered as a service to a third party who accesses the API. In another aspect, the module can include a graphical user interface (GUI), such as that formed by a server serving out hypertext markup language (HTML) code to a browser of a user.

In some cases, an additional step includes making the overall healthiness index score for the at least one payment card account for the predetermined time period available to at least one appropriate party, wherein the results include an epidemiological predictor (broadly understood to include correlation, prediction, and causation). For example, in some cases, the epidemiological predictor includes at least one of a correlation and a prediction regarding patronizing at least one of the first and second pluralities of merchants and incidence of a certain disease.

### System and Article of Manufacture Details

Embodiments of the disclosure can employ hardware and/or hardware and software aspects. Software includes, but is not limited to, firmware, resident software, microcode, etc. Software might be employed, for example, in connection with one or more of analytical suite 406 and its related modules; a terminal 122, 124, 125, 126; a reader module 132; a host, server, and/or processing center 140, 142, 144 (optionally with data warehouse 154) of a merchant, issuer, acquirer, processor, or operator of a payment network 2008, operating according to a payment system standard (and/or specification); and the like. Firmware might be employed, for example, in connection with payment devices such as cards 102, 112, as well as reader module 132.

FIG. 5 is a block diagram of a system 500 that can implement part or all of one or more aspects or processes of the disclosure. As shown in FIG. 5, memory 530 configures the processor 520 (which could correspond, e.g., to processor portions 106, 116, 130; a processor of a terminal or a reader module 132; processors of remote hosts in centers 140, 142, 144; processors of hosts and/or servers implementing various functionality such as that of analytical suite 406; and the like); to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an application-specific integrated circuit (ASIC) rather than using firmware. Display 540 is representative of a variety of possible input/output devices (e.g., displays, printers, keyboards, mice, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010; on a computer implementing analytical suite 406 interacting with transaction database 2021; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the disclosure, such as, for example, 122, 124, 125, 126, 140, 142, 144, 2004, 2006, 2008, 2010; a computer implementing analytical suite 406 interacting with transaction database 2021, and the like, can make use of computer technology with appropriate instructions to implement method steps described herein. Some aspects can be implemented, for example, using one or more servers that include a memory and at least one processor coupled to the memory. The memory could load appropriate software. The processor can be operative to perform one or more method steps described herein or otherwise facilitate their performance.

Accordingly, it will be appreciated that one or more embodiments of the disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, or other input/output components. A “host” includes a physical data processing system (for example, system 500 as shown in FIG. 5) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures.

In one or more embodiments, the modules include a database management system (DBMS) module 408 with aggregation logic module 422; an analysis engine module 410; and a user interface module 414; together forming analytical suite 406. Databases 2021, 420, and 430 are stored in non-volatile (persistent) memory such as a hard drive or drives and accessed by DBMS 408 and/or aggregation logic 422 thereof. Output 416 can be provided from UI module 414. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

One example of user interface module 414 is hypertext markup language (HTML) code served out by a server operated by payment network 2008 or the like, to a browser of a computing device of a user. The HTML is parsed by the browser on the user's computing device to create a graphical user interface (GUI). In some cases, payment network 2008 may operate a service for an issuer 2010, merchant 2004, or the like and the UI 414 involves an API or the like that provides the issuer or merchant with visibility into and/or recommendations based on the results of method 300; the user in such cases may interact, for example, with a GUI provided by the issuer and/or merchant.

One or more embodiments employ special-purpose data warehouse appliances and advanced analytics applications for uses including enterprise data warehousing, business intelligence, predictive analytics and business continuity planning, available from Netezza, a subsidiary of International Business Machines Corporation, Armonk, N.Y., USA. Some embodiments use logic built into SQL scripts with the Netezza appliances and applications.

Computers discussed herein can be interconnected, for example, by one or more of network 138, 2008, another virtual private network (VPN), the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, and the like (an exemplary and non-limiting list), and can also make use of, for example, Extensible Markup Language (XML), known application programs such as relational database applications, spreadsheets, and the like. Some embodiments make use of SAS software, the Python programming language, and/or the R software environment for statistical computing and graphics. SQL or Structured Query Language is a special-purpose programming language designed for managing data held in a relational database management system (RDMS). SQL and RDMS are non-limiting examples of suitable query techniques and database management systems, respectively. The computers can be programmed to implement the logic depicted in the figures. In some instances, messaging and the like may be in accordance with ISO Specification 5583 Financial transaction card originated messages—Interchange message specifications and/or the ISO 20022 or UNIFI Standard for Financial Services Messaging, also incorporated herein by reference in its entirety for all purposes.

Although illustrative embodiments have been described herein with reference to the accompanying drawings, it is to be understood that those precise embodiments are non-limiting, and that various other changes and modifications may be made by one skilled in the art without departing from the scope or spirit of the disclosure.

Reproduction of Certain Portions of U.S. patent application Ser. No. 13/721,216 of First Named Inventor Curtis Villars, Filed Dec. 20, 2012 and Entitled METHOD AND SYSTEM FOR ASSIGNING SPENDING BEHAVIORS TO GEOGRAPHIC AREAS

The present disclosure provides a description of a system and method for assigning spending behaviors to geographic areas.

A method for identifying spending behaviors in a geographic area includes: storing, in a database, a plurality of geographic centroids, wherein each geographic centroid corresponds to a centroid of a predefined geographic area; receiving, by a receiving device, a plurality of financial transactions involving each consumer of a plurality of consumers; identifying, by a processing device, a geographic location of each financial transaction of the plurality of financial transactions; calculating, for each consumer of the plurality of consumers, a purchase centroid of the financial transactions involving the consumer based on a centroid of the identified geographic location of each of the financial transactions involving the consumer; analyzing, for each consumer, spending behaviors based on the financial transactions involving the consumer; associating the analyzed spending behavior for each consumer with the corresponding purchase centroid; associating, in the database, the analyzed spending behaviors for each purchase centroid with a predetermined number of geographic centroids based on the distance from the purchase centroid to each of the predetermined number of geographic centroids; and aggregating, in the database, each of the spending behaviors associated with each geographic centroid of the plurality of geographic centroids such that each corresponding geographic area is associated with aggregated spending behaviors.

A system for identifying spending behaviors in a geographic area includes a database, a receiving device, and a processing device. The database is configured to store a plurality of geographic centroids, wherein each geographic centroid corresponds to a centroid of a predefined geographic area. The receiving device is configured to receive a plurality of financial transactions involving each consumer of a plurality of consumers. The processing device is configured to: identify a geographic location of each financial transaction of the plurality of financial transactions; calculate, for each consumer of the plurality of consumers, a purchase centroid of the financial transactions involving the consumer based on a centroid of the identified geographic location of each of the financial transactions involving the consumer; analyze, for each consumer, spending behaviors based on the financial transactions involving the consumer; associating the analyzed spending behavior for each consumer with the corresponding purchase centroid; associate, in the database, the analyzed spending behaviors for each purchase centroid with a predetermined number of geographic centroids based on the distance from the purchase centroid to each of the predetermined number of geographic centroids; and aggregate, in the database, each of the spending behaviors associated with each geographic centroid of the plurality of geographic centroids such that each corresponding geographic area is associated with aggregated spending behaviors.

### System for Assigning Spend Behaviors to Geographic Areas

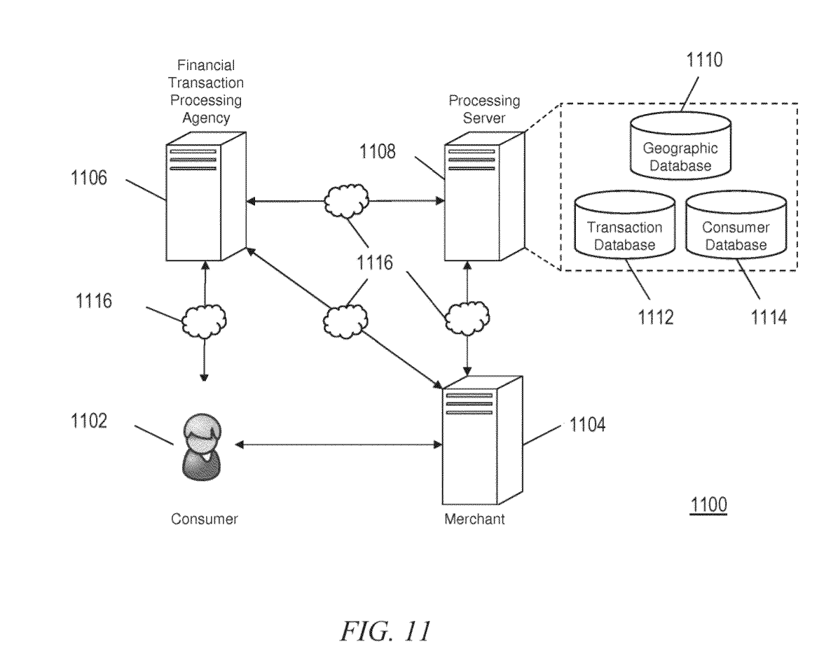

FIG. 11 illustrates a system 1100 for assigning consumer spend behaviors to a plurality of geographic areas based on purchase and geographic centroids. Several of the components of the system 1100 may communicate via a network 1116. The network 1116 may be any network suitable for performing the functions as disclosed herein and may include a local area network (LAN), a wide area network (WAN), a wireless network (e.g., Wi Fi), a mobile communication network, a satellite network, the Internet, fiber optic, coaxial cable, infrared, radio frequency (RF), or any combination thereof. Other suitable network types and configurations will be apparent to persons having skill in the relevant art.

The system 1100 may be used by a consumer 1102 who engages in a financial transaction with a merchant 1104. The financial transaction may be an in-person financial transaction (e.g., at a physical location of the merchant 1104) or may be performed remotely, such as via telephone, mail, or the Internet (e.g., “card not present” transactions). The financial transaction may be processed by a financial transaction processing agency 1106. The financial transaction processing agency 1106 may use any type of processing system configured to process financial transactions as part of a traditional four-party transaction processing system as apparent to persons having skill in the relevant art, such as MasterCard® or VISA®.

For example, the merchant 1104 may submit transaction details for the financial transaction to an acquiring bank, which may submit an authorization request to the financial transaction processing agency 1106. The financial transaction processing agency 1106 may contact an issuing bank that has issued a payment card used in the transaction to the consumer 1102 for approval of the transaction, which may subsequently be forwarded on to the acquiring bank and/or the merchant 1104. The financial transaction processing agency 1106 may identify and store transaction information for each financial transaction processed. Transaction information may include, for example, payment method, transaction amount, merchant identification, transaction location, merchant industry, transaction time and date, etc.

The merchant 1104 may have a desire to advertise to consumers, such as the consumer 1102, that have a frequency of transacting in the geographic area of a physical location of the merchant 1104. In order to identify these consumers, the merchant 1104 may submit a request to a processing server 1108. The processing server 1108, as discussed in more detail below, may receive transaction information from the financial transaction processing agency 1106 and store the received information in a transaction database 1112. In an exemplary embodiment, the transaction information received and stored in the transaction database 1112 may not include any personally identifiable information. In one embodiment, the processing server 1108 and the financial transaction processing agency 1106 may be a single entity.

The processing server 1108 may also include a geographic database 1110, configured to store geographic areas and their associated geographic centroids, as discussed in more detail below. The processing server 1108 may be configured to identify purchase centroids for consumers, by methods as discussed herein and apparent to persons having skill in the relevant art, based on associated transaction information stored in the transaction database 1112. The processing server 1108 may also be configured to analyze spend behaviors for consumers (e.g., the consumer 1102) based on the transaction information. The processing server 1108 may be further configured to identify a predetermined number of geographic centroids based on the distance from a purchase centroid to the corresponding geographic centroids, and associate the analyzed spend behaviors with the identified geographic areas. The corresponding data may be aggregated and used in order to identify consumers to respond to the request of the merchant 1104.

### Processing Server

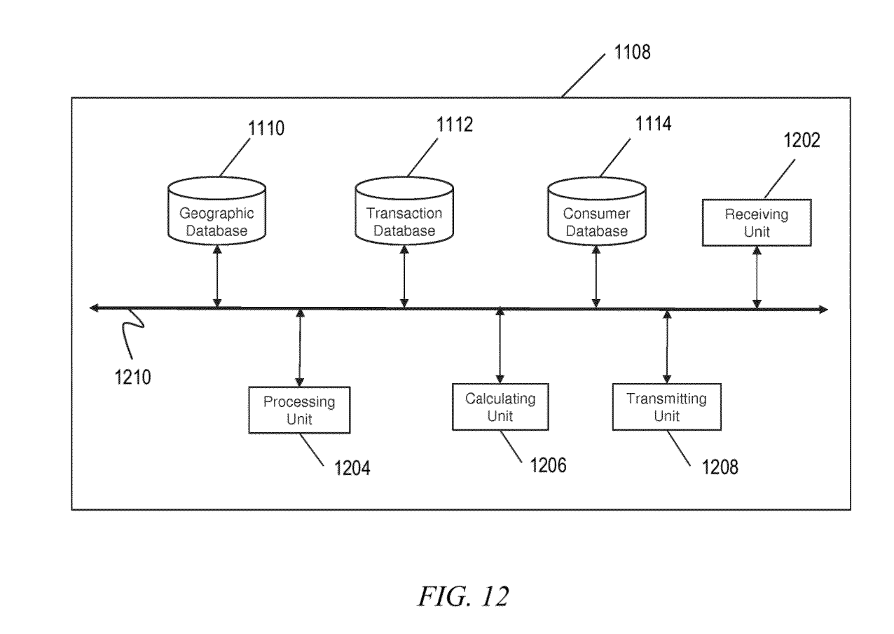

FIG. 12 illustrates an embodiment of the processing server 1108. The processing server 1108 may be any kind of server configured to perform the functions as disclosed herein, such as the computer system illustrated in FIG. 5 and described in more detail elsewhere herein. The processing server 1108 may include the geographic database 1110, the transaction database 1112, a consumer database 1114, a receiving unit 1202, a processing unit 1204, a calculating unit 1206, and a transmitting unit 1208. Each of the components may be connected via a bus 1210. Suitable types and configurations of the bus 1210 will be apparent to persons having skill in the relevant art.

Data stored in the geographic database 1110, the transaction database 1112, and the consumer database 1114 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SOL) database, a distributed database, an object database, etc. Suitable configurations and database storage types will be apparent to persons having skill in the relevant art. The databases may each be a single database, or may comprise multiple databases, which may be interfaced together (e.g., physically or via a network, such as the network 1116).

The geographic database 1110, as discussed in more detail below, may be configured to store information regarding a plurality of geographic areas and corresponding geographic centroids. A geographic centroid may be a centroid of the corresponding geographic area as identified and/or calculated (e.g., by the calculating unit 1206) by the processing server 1108. Methods for calculating or identifying the centroid of an area will be apparent to persons having skill in the relevant art and may include a plumb line or balancing method, geometric decomposition, integral formula, etc.

The transaction database 1112 may be configured to store transaction information corresponding to a plurality of financial transactions including a plurality of consumers. In an exemplary embodiment, the transaction information may contain no personally identifiable information. The transaction information may include any information suitable for performing the functions as disclosed herein, such as transaction location, merchant identification, transaction time and/or date, transaction amount, payment method, etc. The consumer database 1114 may be configured to store consumer profile information for a plurality of consumers as discussed in more detail below.

The receiving unit 1202 may be configured to receive transaction information for a plurality of transactions, which may be stored (e.g., via the processing unit 1204) in the transaction database 1112. In embodiments where the processing server 1108 may also operate as the financial transaction processing agency 1106, the receiving unit 1202 may be further configured to receive authorization requests for financial transactions. The receiving unit 1202 may also be configured to receive requests from merchants (e.g., the merchant 1104) for spending behaviors in at least one geographic area.

The processing unit 1204 may be configured to identify a geographic location of each financial transaction stored in the transaction database 1112. In one embodiment, the geographic location may be directly included in the transaction information. In another embodiment, the processing unit 1204 may identify a geographic location associated with the merchant included in the financial transaction (e.g., by utilizing a lookup table of geographic locations and merchant identification numbers). Other methods for identifying geographic locations of financial transactions will be apparent to persons having skill in the relevant art, such as receiving the geographic location from a mobile communication device used in the financial transaction (e.g., for payment via an electronic wallet).

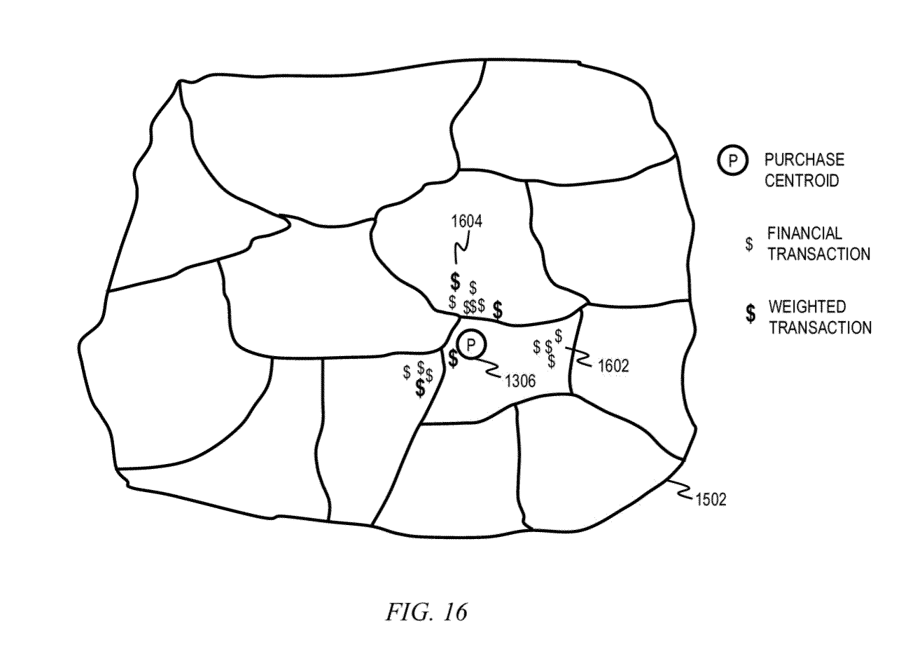

The calculating unit 1206 may be configured to calculate a purchase centroid for each consumer based on the identified geographic locations of the financial transactions included the respective consumer, as discussed in more detail below with respect to FIG. 16. The processing unit 1204 may be configured to store the calculated purchase centroid in the consumer database 1114 in a consumer data entry corresponding to the associated consumer.

The processing unit 1204 may be further configured to analyze, for each consumer, spending behaviors based on the financial transactions including the consumer and stored in the transaction database 1112. Spending behaviors may include, for example, propensity to spend, propensity to spend in a particular industry, propensity to spend at a particular merchant, transaction frequency, transaction frequency in a particular industry or at a particular merchant, regular spend amount, regular spend amount in a particular industry or at a particular merchant, propensity to spend at specific dates and/or times, and other behaviors as will be apparent to persons having skill in the relevant art. The processing unit 1204 may then associate the analyzed spending behaviors to the consumer's corresponding purchase centroid.

The processing unit 1204 (e.g., or the calculating unit 1206) may be further configured to identify a predetermined number of geographic areas based on the distance from a purchase centroid to the corresponding geographic centroid, and associate the corresponding spend behaviors to the geographic area. It will be apparent to persons having skill in the relevant art that the predetermined number of geographic areas may vary from application to application. For example, in some industries where consumers are less likely to commute a long distance to transact, such as grocery shopping, the predetermined number may be based on a particular distance (e.g., 5 miles for a rural region). In industries where consumers are more likely to commute, such as for specialty items, the predetermined number may be based on a further distance (e.g., 25 miles). In some instances, the predetermined number of geographic areas may be an integer number, such as the five closest geographic areas.

The processing unit 1204 may also be configured to aggregate the spending behaviors associated with a geographic area in order to identify an overall (e.g., average) spending behavior for consumers that regularly transact in or near the geographic area. The transmitting unit 1208 may be configured to transmit the aggregated spending behaviors to the merchant 1104, such as in response to a request for spending behaviors. The aggregated spending behaviors may be for the geographic area including the merchant 1104, or the geographic area may be selected based on the corresponding spending behaviors. For example, the merchant 1104 may request the geographic area for all consumers with a specified propensity to spend in its respective industry, so that the merchant 1104 can advertise to the consumers in that geographic area.

### Consumer and Geographic Databases

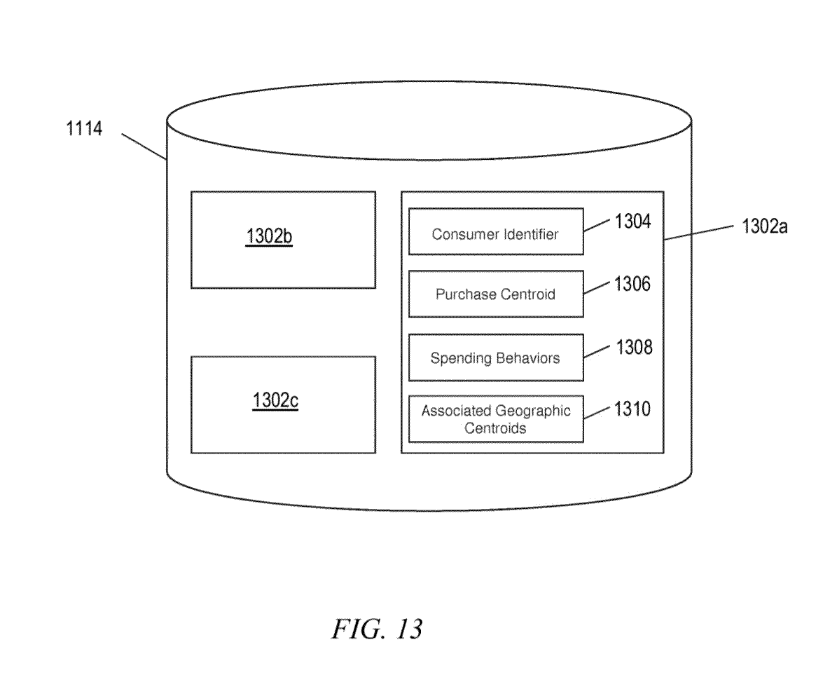

FIG. 13 illustrates the consumer database 1114 of the processing server 1108. The consumer database 1114 may include a plurality of consumer data entries 1302, illustrated as consumer data entries 1302a, 1302b, and 1302c. Each consumer data entry 1302 may include at least a consumer identifier 1304, a purchase centroid 1306, spending behaviors 1308, and associated geographic centroids 1310. It will be apparent to persons having skill in the relevant art that the associated geographic centroids 1310 may be optional, e.g., and alternatively stored in the geographic database 1110.

The consumer identifier 1304 may be a unique value associated with a consumer (e.g., the consumer 1102) for identification of the consumer. In one embodiment, the consumer identifier 1304 may be an account number, such as for a payment card account. In another embodiment, the consumer identifier 1304 may be a unique value identified and/or generated by the processing server 1108 (e.g., via the processing unit 1204). The consumer identifier 1304 may be used in order to associate the consumer 1102 with the financial transactions including the consumer 1102 stored in the transaction database 1112.

The purchase centroid 1306 may be a purchase centroid associated with the consumer 1102 based on the geographic location of financial transactions including the consumer 1102, as described in more detail below. In an exemplary embodiment, the purchase centroid 1306 may be a geographic location represented using latitude and longitude. The spending behaviors 1308 may be spending behaviors associated with the consumer 1102 based on analysis of financial transactions including the consumer 1102 and stored in the transaction database 1112. Behaviors included in the spending behaviors 1308 may include propensity to spend, propensity to spend in a particular industry, etc. as discussed above.

The associated geographic centroids 1310 may include geographic centroids (e.g., or their corresponding geographic areas) for which the consumer's purchase centroid 1306 is associated. In some embodiments, the associated geographic centroids 1310 may only include a single geographic centroid (e.g., the closest geographic centroid to the purchase centroid 1306). In other embodiments, the number of geographic centroids included in the associated geographic centroids 1310 may be based on a variety of factors, such as requested number of areas, spending behaviors, geographic area selection, etc.

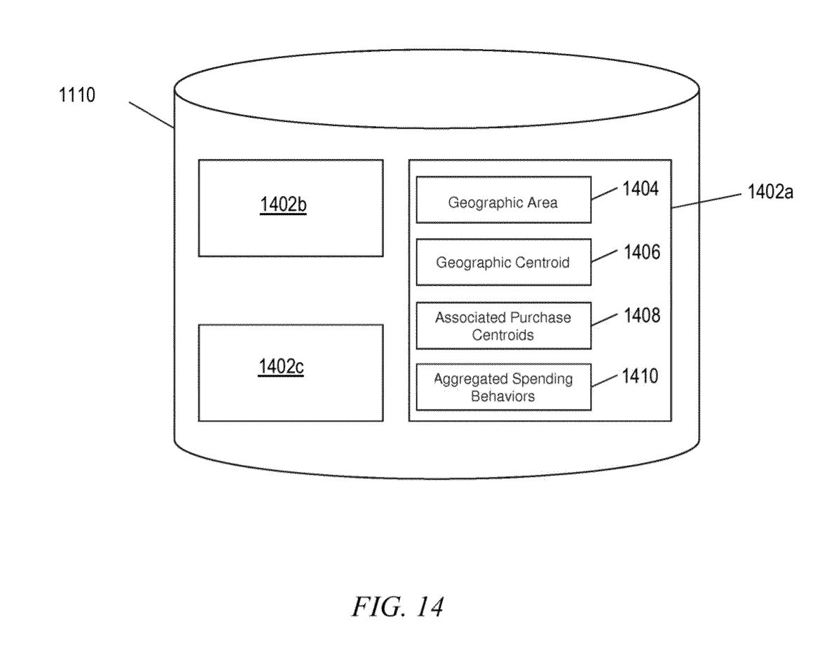

FIG. 14 is an illustration of the geographic database 1110 of the processing server 1108. The geographic database 1110 may include a plurality of geographic data entries 1402, illustrated as geographic data entries 1402a, 1402b, and 1402c. Each geographic data entry 1402 may include a geographic area 1404, a geographic centroid 1406, associated purchase centroids 1408, and aggregated spending behaviors 1410. Additional information that may be included in the geographic database 1110 will be apparent to persons having skill in the relevant art.

The geographic area 1404 may be any geographic area for which spending behaviors may be aggregated. For example, the geographic area 1404 may be a zip code or postal code, a county, a municipality, a shopping district, shopping center, or any other defined geographic area as will be apparent to persons having skill in the relevant art. In an exemplary embodiment, the geographic area 1404 may be defined using latitude and longitude. The geographic centroid 1406 may be the calculated or identified centroid of the geographic area 1404. Methods used for calculating or identifying the geographic centroid of an area will be apparent to persons having skill in the relevant art. The associated purchase centroids 1408 may include all purchase centroids (e.g., or consumer data entries 1302 including the respective purchase centroids) associated with the geographic area 1404 as discussed herein. The aggregated spending behaviors 1410 may include an aggregation of spending behaviors for each of the consumer data entries 1302 corresponding to each purchase centroid 1306 in the associated purchase centroids 1408. As such, the aggregated spending behaviors 1410 may be a representation of the spending behavior of consumers that regularly transact in or near the geographic area 1404.

### Geographic and Purchase Centroids

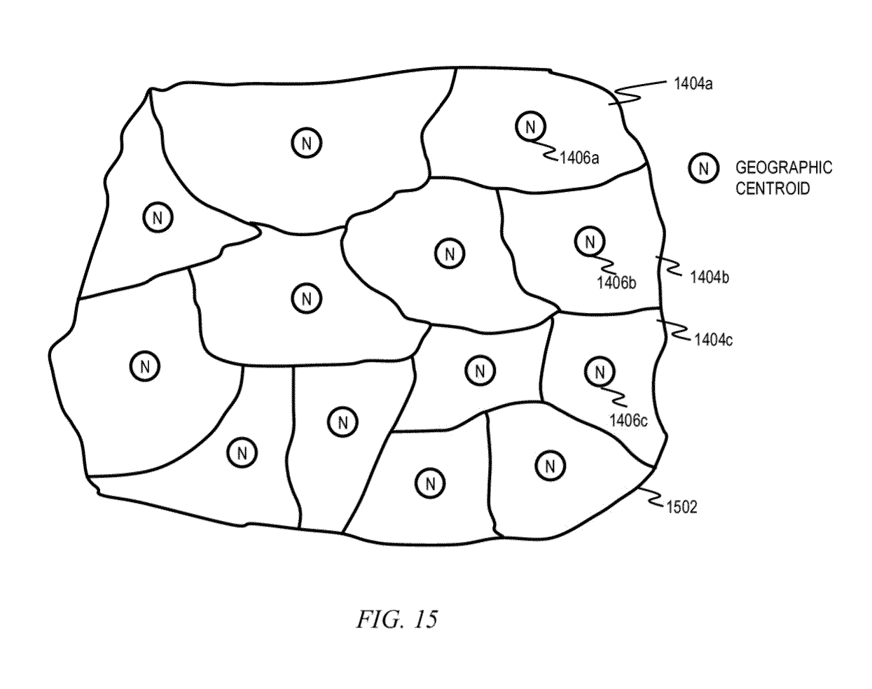

FIG. 15 is an illustration of an area 1502 that includes a plurality of geographic areas 1404, illustrated as geographic area 1404a, 1404b, and 1404c. As discussed previously, each geographic area 1404 may have a corresponding geographic centroid 1406. The geographic centroid 1406 may be the centroid, or the geometric center, of the corresponding geographic area 1404. As illustrated in FIG. 15, geographic areas 1404a, 1404b, and 1404c each include a corresponding geographic centroid 1406a, 1406b, and 1406c, respectively.

FIG. 16 is an illustration of the area 1502 as displaying a plurality of financial transactions 1602. The plurality of financial transactions 1602 may include those financial transactions that include a specific consumer 1102, such as based on the associated consumer identifier 1304. The financial transactions 1602 may be displayed based on their geographic location, which may be utilized using methods as discussed herein in order to calculate or identify the purchase centroid 1306 corresponding to the financial transactions.

In some embodiments, the financial transactions 1602 may include weighted financial transactions, such as the weighted transactions 1604. Weighted transactions may be financial transactions that have greater weight when calculating or identifying the purchase centroid 1306. A transaction may have a greater weight depending on the circumstances and application. For example, transactions may be weighted based on the transaction amount, such that large transactions are considered more heavily than smaller transactions for the calculation of the purchase centroid 1306. Similarly, if spending behaviors are analyzed for a particular industry, financial transactions that include a merchant within that industry may be viewed as weighted transactions 1604. In some instances, all of the financial transactions 1602 may include only those transactions of a specific industry. Other considerations for the weighting of financial transactions will be apparent to persons having skill in the relevant art, such as time of day, day of the week, season (e.g., summer spending as opposed to winter spending), etc.

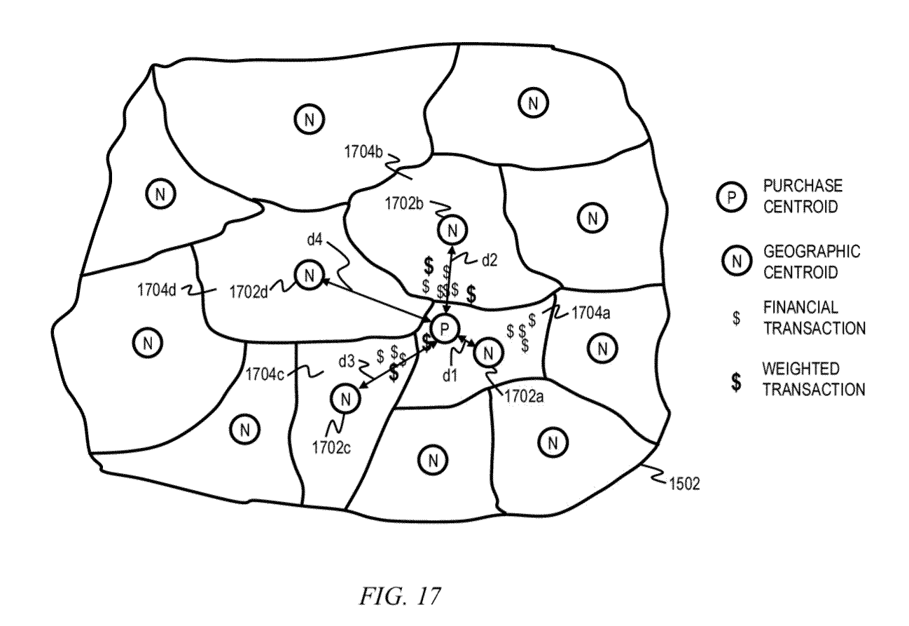

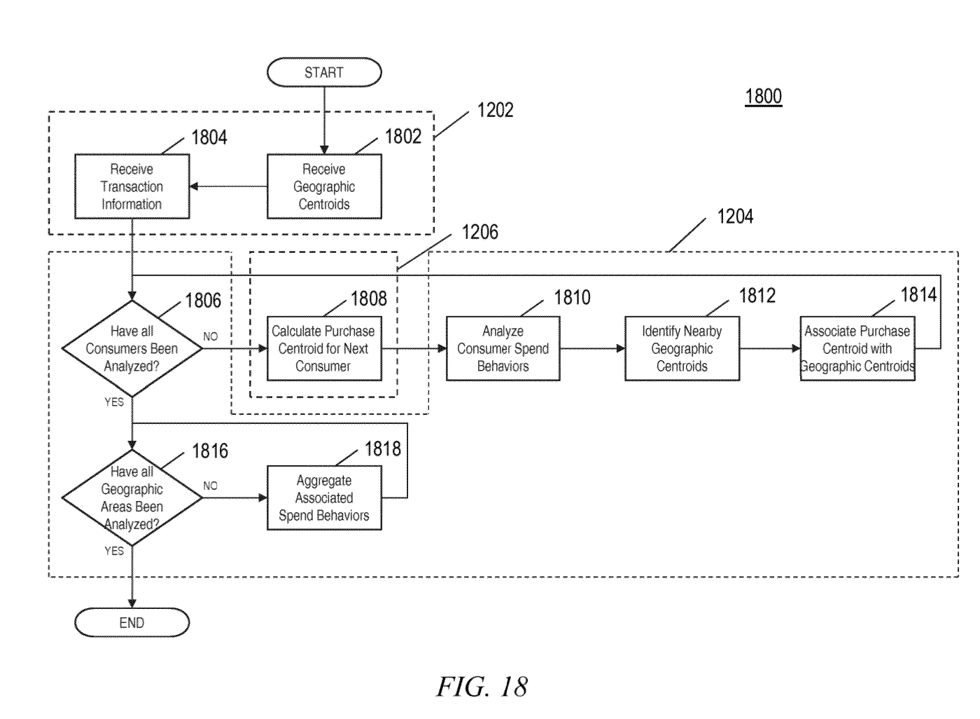

FIG. 17 illustrates the area 1502 and the identification of geographic centroids 1406 to be associated with the purchase centroid 1306 associated with the consumer 1102. As illustrated in FIGS. 15 and 16, in the area 1502, the geographic centroid 1406 has been identified and the purchase centroid 1306 for the financial transactions 1602 has been identified. Based on this information, as discussed herein, a predetermined number of geographic centroids 1406 may be identified based on the distance from the purchase centroid 1306 to the corresponding geographic centroid 1406. In one embodiment, the predetermined number of geographic centroids may be 4, or may be all geographic centroids 1406 within a distance d4 from the purchase centroid 1306, as illustrated in FIG. 17.

Based on the distances d1, d2, d3, and d4, the plurality of geographic centroids 1702 may be identified as those geographic centroids 1702 that fit the criteria for establishing the predetermined number of centroids. The processing server 1204 may then update the corresponding consumer data entry 1302 to reflect geographic centroids 1702a, 1702b, 1702c, and 1702d as the associated geographic centroids 1310 associated with the purchase centroid 1306. In addition, the processing server 1204 may update the corresponding geographic data entry 1402 including each of the identified geographic areas 1704a, 1704b, 1704c, and 1704d as including the purchase centroid 1306 in the respective associated purchase centroids 1408.

### Method for Analyzing and Aggregating Spending Behaviors

FIG. 18 illustrates a method 1800 for the analyzing and aggregation of spending behaviors for a geographic area.

In step 1802, a plurality of geographic centroids 1406 may be received. Each geographic centroid 1406 may be associated with a predefined geographic area 1404. In one embodiment, the geographic centroids 1406 may be stored in the geographic database 1110, as discussed above. In one embodiment, the geographic areas 1404 may be based on a zip code or postal code, may be defined by latitude or longitude boundaries, may be based on municipal boundaries, or a combination thereof.

In step 1804, transaction information for a plurality of financial transactions including a plurality of consumers may be received (e.g., and subsequently stored in the transaction database 1112). Steps 1802 and 1804 may be performed by the receiving unit 1202. In some embodiments, step 1802 may include only the receipt of a plurality of geographic areas 1404, from which the corresponding geographic centroids 1406 may be calculated (e.g., by the calculating unit 1206).

In step 1806, it may be determined (e.g., by the processing unit 1204) if all consumers have been analyzed. If not, then, in step 1808, the calculating unit 1206 may calculate the purchase centroid 1306 for the next consumer (e.g., corresponding to the next unanalyzed consumer data entry 1302). Methods for calculating the purchase centroid 1306 will be apparent to persons having skill in the relevant art as discussed herein, such as identifying the geographic location of each financial transaction including the consumer and calculating the purchase centroid 1306 using known centroid calculation methods.

In step 1810, the processing unit 1204 may analyze the financial transactions including the consumer to determine consumer spend behaviors. In some embodiments, the consumer spend behaviors determined may be based on the application of the data. For example, the consumer spend behaviors may include spend propensity for a specific industry, such as the industry of the merchant 1104 requesting the information. The processing unit 1204 may store the analyzed spend behaviors in the corresponding consumer data entry 1302 in the consumer database 1114 as the included spending behaviors 1308. In step 1812, the processing unit 1204 may identify a predetermined number of geographic centroids near the purchase centroid 1306. In some embodiments, the predetermined number of geographic centroids may be based on distance to the purchase centroid (e.g., all geographic centroids within 20 miles), based on a specific number (e.g., the 5 closest geographic centroids) or other criteria as will be apparent to persons having skill in the relevant art.

In step 1814, the processing unit 1204 may associate the purchase centroid 1306 with the identified geographic centroids. Associating the purchase centroid 1306 with the identified geographic centroids may include storing, in the corresponding consumer data entry 1302, the associated geographic centroids 1310, or storing, in the corresponding geographic data entry 1402 for each identified geographic centroid, the purchase centroid 1306 as an associated purchase centroid 1408. Then, the method 1800 may return to step 1806 and again determine if all consumers have been analyzed.

Once all consumers have been analyzed, then, in step 1816, the processing unit 1204 may determine if all geographic areas 1404 (e.g., based on the corresponding geographic data entries 1402) have been analyzed. If they have not, then, in step 1818, the processing unit 1204 may aggregate the spending behaviors associated with each geographic data entry 1402. Aggregating the spending behaviors for each geographic data entry 1402 may include identifying the consumer data entry 1302 for each purchase centroid 1306 included in the associated purchase centroids 1408, and aggregating the corresponding spending behaviors 1308 for each identified consumer data entry 1302. In one embodiment, the processing unit 1204 may store the aggregated spending behaviors 1410 in the corresponding geographic data entry 1402. Following this, the processing unit 1204 may again determine, in step 1816, if all geographic areas 1404 have been analyzed. If all have been analyzed (e.g., spending behaviors aggregated for each geographic area 1404), then the method 1800 may be completed.

### Exemplary Method for Assigning Spending Behaviors to Geographic Areas

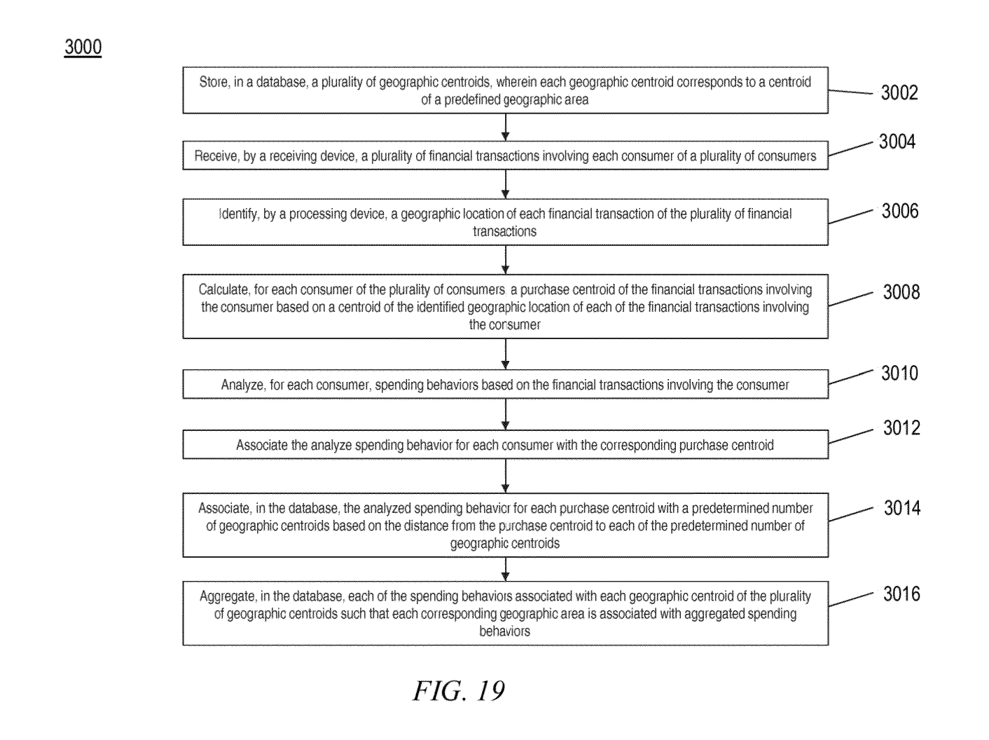

FIG. 19 illustrates a method 3000 for assigning consumer spend behaviors to geographic areas via the use of purchase and geographic centroids.

In step 3002, a plurality of geographic centroids (e.g., geographic centroids 1406) may be stored in a database (e.g., the geographic database 1110), wherein each geographic centroid 1406 corresponds to a centroid of a predefined geographic area (e.g., geographic area 1404). In one embodiment, the predefined geographic area may be based on a zip code or a postal code. In another embodiment, the predefined geographic area may be defined by latitude and longitude measurements. In yet another embodiment, the predefined geographic area may be based on municipal boundaries.

In step 3004, a plurality of financial transactions including each consumer of a plurality of consumers may be received by a receiving device (e.g., the receiving unit 1202). In step 3006, a processing device (e.g., the processing unit 1204) may identify a geographic location of each financial transaction of the plurality of financial transactions. In one embodiment, identifying the geographic location of each financial transaction may include identifying, in a database, the latitude and longitude of a merchant point of sale included in the financial transaction. In another embodiment, identifying the geographic location of each financial transaction may include identifying the geographic location of a mobile communication device used as a payment method in the respective financial transaction.

In step 3008, a purchase centroid (e.g., the purchase centroid 1306) of the financial transactions involving a consumer may be calculated (e.g., by the calculating unit 1206) for each consumer of the plurality of consumers, based on a centroid of the identified geographic location of each of the financial transactions involving the consumer. In one embodiment, calculating the purchase centroid 1306 of the financial transactions may include weighing or filtering the financial transactions based on predetermined factors. In a further embodiment, the predetermined factors may include at least one of: merchant code or type, product category, transaction amount, transaction frequency, and geographic location of the transaction. In another embodiment, the plurality of financial transactions may include only financial transactions of a predetermined category. In a further embodiment, the predetermined category may be based on at least one of: time of day, day of the week, month, season, home location, employment location, merchant code, product category, industry code, and transaction amount. In some embodiments, multiple purchase centroids may be calculated for each consumer, such as purchase centroids for each of a number of predetermined categories.

In step 3010, spending behaviors (e.g., the spending behaviors 1308) for each consumer may be analyzed (e.g., by the processing unit 1204) based on the financial transactions including the consumer. In one embodiment, the spending behaviors 1308 may include at least one of: propensity to spend, propensity to spend in a particular industry, frequency of spending, amount of spending, industry preference, brand preference, and time of spending. In step 3012, the analyzed spending behavior 1308 for each consumer may be associated with the corresponding purchase centroid 1306. Further details of consumer spending analysis can be found, e.g., in U.S. Patent Publication 2013-0024242, “Protecting Privacy in Audience Creation” of Villars et al., expressly incorporated by reference herein in its entirety for all purposes.

In step 3014, the analyzed spending behavior 1308 for each purchase centroid 1306 may be associated, in the geographic database 1110, with a predetermined number of associated geographic centroids 1310 based on the distance from the purchase centroid 1306 to each of the predetermined number of associated geographic centroids 1310. In one embodiment, the predetermined number of associated geographic centroids 1310 may be based on a privacy concern. In a further embodiment, the privacy concern may be such that no consumer is personally identifiable. In another embodiment, the predetermined number of associated geographic centroids 1310 may include all geographic centroids 1406 in a specified distance radial from the purchase centroid 1306.

In step 3016, each of the spending behaviors 1308 associated with each geographic centroid 1406 of the plurality of geographic centroids 1406 may be aggregated, in the geographic database 1110, such that each corresponding geographic area 1404 may be associated with the aggregated spending behaviors (e.g., the aggregated spending behaviors 1410).

The calculation of purchase centroids on the basis of financial transactions may be beneficial for merchants and advertisers by identifying consumers and spending behaviors for specific locations. It will be apparent to persons having skill in the relevant art that centroids may also be calculated on additional activities and my not be strictly limited to financial transactions. For example, centroids may be calculated based on social network activities (e.g., locations when a consumer posts to Facebook®, Twitter®, FourSquare®, etc.), locations where a consumer sends messages (e.g., short message service messages) or conducts calls from a mobile device, etc.

The identification of purchase centroids and associated spending behaviors may also have additional applications and be beneficial for advertisers and merchants in addition to those discussed herein, as will be apparent to persons having skill in the relevant art. For example, the analysis of purchase centroids based on dates may identify when a consumer moves from one location to another, which may present the consumer as ideal for receiving advertising for offers or services in a new location. Similarly, purchase centroids may identify a consumer that lives in multiple locations (e.g., a seasonal home), which may benefit merchants by knowing that the consumer need only be advertised to for certain periods. Additional uses for purchase centroids and aggregated spending behaviors as discussed herein will be apparent to persons having skill in the relevant art.

Techniques consistent with the present disclosure provide, among other features, systems and methods for assigning spend behaviors to geographic areas.

What is claimed is:

1. A method comprising the steps of:
accessing a database of payment card transaction data and a database of merchant data;
determining per-capita spending at a first plurality of merchants for at least one payment card account for a predetermined time period, said first plurality of merchants having transaction data in said database of payment card transaction data, patronizing said first plurality of merchants being associated with good cardholder health;
determining per-capita spending at a second plurality of merchants for said at least one payment card account for said predetermined time period, said second plurality of merchants having transaction data in said database of payment card transaction data, patronizing said second plurality of merchants being associated with bad cardholder health; and
determining an overall healthiness index score for said at least one payment card account for said predetermined time period, based on comparison of said determined per-capita spending at said first plurality of merchants for said at least one payment card account for said predetermined time period and said determined per-capita spending at said second plurality of merchants for said at least one payment card account for said predetermined time period to respective baseline values.

2. The method of claim 1, wherein:
said determining of said per-capita spending at said first plurality of merchants for said at least one payment card account for said predetermined time period comprises:
querying said database for transactions for a single primary account number (PAN) at said first plurality of merchants during said predetermined time period; and
summing amounts of said transactions for said single primary account number (PAN) at said first plurality of merchants during said predetermined time period; and
said determining of said per-capita spending at said second plurality of merchants for said at least one payment card account for said predetermined time period comprises:
querying said database for transactions for said single primary account number (PAN) at said second plurality of merchants during said predetermined time period; and
summing amounts of said transactions for said single primary account number (PAN) at said second plurality of merchants during said predetermined time period.

3. The method of claim 2, further comprising initiating a health-related offer to a cardholder associated with said single primary account number (PAN), based on said overall healthiness index score.

4. The method of claim 1, wherein:
said determining of said per-capita spending at said first plurality of merchants for said at least one payment card account for said predetermined time period comprises:
querying said database for transactions for a group to be analyzed at said first plurality of merchants during said predetermined time period;
summing amounts of said transactions for said group to be analyzed at said first plurality of merchants during said predetermined time period; and
dividing said summed amounts of said transactions for said group to be analyzed at said first plurality of merchants during said predetermined time period by a number of members of said group to obtain said per-capita spending at said first plurality of merchants; and
said determining of said per-capita spending at said second plurality of merchants for said at least one payment card account for said predetermined time period comprises:
querying said database for transactions for said group to be analyzed at said second plurality of merchants during said predetermined time period;
summing amounts of said transactions for said group to be analyzed at said second plurality of merchants during said predetermined time period; and
dividing said summed amounts of said transactions for said group to be analyzed at said second plurality of merchants during said predetermined time period by said number of members of said group to obtain said per-capita spending at said second plurality of merchants.

5. The method of claim 4, further comprising initiating a health-related advertisement to cardholders associated with said group to be analyzed, based on said overall healthiness index score.

6. The method of claim 1, wherein:
said determining of said per-capita spending at said first plurality of merchants for said at least one payment card account for said predetermined time period comprises:
querying said database for transactions for a single primary account number (PAN) at said first plurality of merchants during said predetermined time period;
summing amounts of said transactions for said single primary account number (PAN) at said first plurality of merchants during said predetermined time period;
repeating said querying and summing steps for said first plurality of merchants during said predetermined time period such that said querying and summing steps are carried out for multiple primary account numbers (PANs); and
averaging results obtained for said multiple primary account numbers (PANs) to obtain said per-capita spending at said first plurality of merchants for said at least one payment card account for said predetermined time period; and
said determining of said per-capita spending at said second plurality of merchants for said at least one payment card account for said predetermined time period comprises:
querying said database for transactions for a single primary account number (PAN) at said second plurality of merchants during said predetermined time period;
summing amounts of said transactions for said single primary account number (PAN) at said second plurality of merchants during said predetermined time period;
repeating said querying and summing steps for said second plurality of merchants during said predetermined time period such that said querying and summing steps are carried out for said multiple primary account numbers (PANs); and
averaging results obtained for said multiple primary account numbers (PANs) to obtain said per-capita spending at said second plurality of merchants for said at least one payment card account for said predetermined time period.

7. The method of claim 6, further comprising initiating a health-related advertisement to cardholders associated with said group to be analyzed, based on said overall healthiness index score.

8. The method of claim 1, further comprising determining per-capita spending at a third plurality of merchants for said at least one payment card account for said predetermined time period, said third plurality of merchants having transaction data in said database of payment card transaction data, patronizing said third plurality of merchants being associated with good cardholder health.
wherein:
said overall healthiness index score for said at least one payment card account for said predetermined time period is further based on comparison of said determined per-capita spending at said third plurality of merchants for said at least one payment card account for said predetermined time period to a respective baseline value;
said first plurality of merchants comprises merchants associated with healthy eating;
said second plurality of merchants comprises merchants associated with unhealthy eating; and
said third plurality of merchants comprises merchants associated with exercise.

9. The method of claim 1, further comprising excluding health care providers from said first and second pluralities of merchants.

10. The method of claim 1, further comprising:
calculating a first one of said respective baseline values, to which said determined per-capita spending at said first plurality of merchants for said at least one payment card account for said predetermined time period is to be compared, wherein said calculating of said first one of said respective baseline values in turn comprises:
querying said database for transactions for a baseline group at said first plurality of merchants during said predetermined time period;
summing amounts of said transactions for said baseline group at said first plurality of merchants during said predetermined time period; and
dividing said summed amounts of said transactions for said baseline group at said first plurality of merchants during said predetermined time period by a number of members of said baseline group to obtain said first one of said respective baseline values; and
calculating a second one of said respective baseline values, to which said determined per-capita spending at said second plurality of merchants for said at least one payment card account for said predetermined time period is to be compared, wherein said calculating of said second one of said respective baseline values in turn comprises:
querying said database for transactions for said baseline group at said second plurality of merchants during said predetermined time period;
summing amounts of said transactions for said baseline group at said second plurality of merchants during said predetermined time period; and
dividing said summed amounts of said transactions for said baseline group at said second plurality of merchants during said predetermined time period by said number of members of said baseline group to obtain said second one of said respective baseline values.

11. The method of claim 1, wherein said determining of said overall healthiness index score for said at least one payment card account for said predetermined time period comprises:
dividing said determined per-capita spending at said first plurality of merchants for said at least one payment card account by a first of said respective baseline values to obtain a first partial index;
annexing a negative sign to said determined per-capita spending at said second plurality of merchants for said at least one payment card account and dividing same by a second of said respective baseline values to obtain a second partial index; and
taking an average of said first and second partial indices to obtain said overall healthiness index score for said at least one payment card account for said predetermined time period.

12. The method of claim 1, wherein:
said accessing of said database of payment card transaction data and said database of merchant data is carried out with a database management system module, embodied on a non-transitory computer-readable storage medium, executing on at least one hardware processor;
said determining of said per-capita spending at said first and second pluralities of merchants for said at least one payment card account for said predetermined time period is carried out with said database management system module and an analysis engine module, embodied on said non-transitory computer-readable storage medium, executing on said at least one hardware processor; and
said determining of said overall healthiness index score for said at least one payment card account for said predetermined time period is carried out with said analysis engine module, embodied on said non-transitory computer-readable storage medium, executing on said at least one hardware processor.

13. The method of claim 1, further comprising making said overall healthiness index score for said at least one payment card account for said predetermined time period available to at least one appropriate party, wherein said results comprise an epidemiological predictor.

14. The method of claim 13, wherein said epidemiological predictor comprises at least one of a correlation and a prediction regarding patronizing at least one of said first and second pluralities of merchants and incidence of a certain disease.

15. An apparatus comprising:
a memory;
at least one processor operatively coupled to said memory; and
a persistent storage device operatively coupled to said memory and storing in a non-transitory manner instructions which when loaded into said memory cause said at least one processor to be operative to:
access a database of payment card transaction data and a database of merchant data;
determine per-capita spending at a first plurality of merchants for at least one payment card account for a predetermined time period, said first plurality of merchants having transaction data in said database of payment card transaction data, patronizing said first plurality of merchants being associated with good cardholder health;
determine per-capita spending at a second plurality of merchants for said at least one payment card account for said predetermined time period, said second plurality of merchants having transaction data in said database of payment card transaction data, patronizing said second plurality of merchants being associated with bad cardholder health; and
determine an overall healthiness index score for said at least one payment card account for said predetermined time period, based on comparison of said determined per-capita spending at said first plurality of merchants for said at least one payment card account for said predetermined time period and said determined per-capita spending at said second plurality of merchants for said at least one payment card account for said predetermined time period to respective baseline values.

16. The apparatus of claim 15, wherein said persistent storage device further stores in said non-transitory manner instructions which when loaded into said memory cause said at least one processor to be further operative to:
determine said per-capita spending at said first plurality of merchants for said at least one payment card account for said predetermined time period by:
querying said database for transactions for a single primary account number (PAN) at said first plurality of merchants during said predetermined time period; and
summing amounts of said transactions for said single primary account number (PAN) at said first plurality of merchants during said predetermined time period; and
determine said per-capita spending at said second plurality of merchants for said at least one payment card account for said predetermined time period by:
querying said database for transactions for said single primary account number (PAN) at said second plurality of merchants during said predetermined time period; and
summing amounts of said transactions for said single primary account number (PAN) at said second plurality of merchants during said predetermined time period.

17. The apparatus of claim 15, wherein said persistent storage device further stores in said non-transitory manner instructions which when loaded into said memory cause said at least one processor to be further operative to:
determine said per-capita spending at said first plurality of merchants for said at least one payment card account for said predetermined time period by:
querying said database for transactions for a group to be analyzed at said first plurality of merchants during said predetermined time period;
summing amounts of said transactions for said group to be analyzed at said first plurality of merchants during said predetermined time period; and
dividing said summed amounts of said transactions for said group to be analyzed at said first plurality of merchants during said predetermined time period by a number of members of said group to obtain said per-capita spending at said first plurality of merchants; and
determine said per-capita spending at said second plurality of merchants for said at least one payment card account for said predetermined time period by:
querying said database for transactions for said group to be analyzed at said second plurality of merchants during said predetermined time period;
summing amounts of said transactions for said group to be analyzed at said second plurality of merchants during said predetermined time period; and
dividing said summed amounts of said transactions for said group to be analyzed at said second plurality of merchants during said predetermined time period by said number of members of said group to obtain said per-capita spending at said second plurality of merchants.

18. The apparatus of claim 15, wherein said persistent storage device further stores in said non-transitory manner instructions which when loaded into said memory cause said at least one processor to be further operative to:
determine said per-capita spending at said first plurality of merchants for said at least one payment card account for said predetermined time period by:
querying said database for transactions for a single primary account number (PAN) at said first plurality of merchants during said predetermined time period;
summing amounts of said transactions for said single primary account number (PAN) at said first plurality of merchants during said predetermined time period;
repeating said querying and summing steps for said first plurality of merchants during said predetermined time period such that said querying and summing steps are carried out for multiple primary account numbers (PANs); and
averaging results obtained for said multiple primary account numbers (PANs) to obtain said per-capita spending at said first plurality of merchants for said at least one payment card account for said predetermined time period; and
determine said per-capita spending at said second plurality of merchants for said at least one payment card account for said predetermined time period by:
querying said database for transactions for a single primary account number (PAN) at said second plurality of merchants during said predetermined time period;
summing amounts of said transactions for said single primary account number (PAN) at said second plurality of merchants during said predetermined time period;
repeating said querying and summing steps for said second plurality of merchants during said predetermined time period such that said querying and summing steps are carried out for said multiple primary account numbers (PANs); and
averaging results obtained for said multiple primary account numbers (PANs) to obtain said per-capita spending at said second plurality of merchants for said at least one payment card account for said predetermined time period.

19. The apparatus of claim 15, wherein said persistent storage device further stores in said non-transitory manner instructions which when loaded into said memory cause said at least one processor to be further operative to determine per-capita spending at a third plurality of merchants for said at least one payment card account for said predetermined time period, said third plurality of merchants having transaction data in said database of payment card transaction data, patronizing said third plurality of merchants being associated with good cardholder health.
wherein:
said overall healthiness index score for said at least one payment card account for said predetermined time period is further based on comparison of said determined per-capita spending at said third plurality of merchants for said at least one payment card account for said predetermined time period to a respective baseline value;
said first plurality of merchants comprises merchants associated with healthy eating;
said second plurality of merchants comprises merchants associated with unhealthy eating; and
said third plurality of merchants comprises merchants associated with exercise.

20. The apparatus of claim 15, wherein said persistent storage device further stores in said non-transitory manner instructions which when loaded into said memory cause said at least one processor to be further operative to exclude health care providers from said first and second pluralities of merchants.

21. The apparatus of claim 15, wherein said persistent storage device further stores in said non-transitory manner instructions which when loaded into said memory cause said at least one processor to be further operative to:
calculate a first one of said respective baseline values, to which said determined per-capita spending at said first plurality of merchants for said at least one payment card account for said predetermined time period is to be compared, wherein said calculating of said first one of said respective baseline values in turn comprises:
querying said database for transactions for a baseline group at said first plurality of merchants during said predetermined time period;
summing amounts of said transactions for said baseline group at said first plurality of merchants during said predetermined time period; and
dividing said summed amounts of said transactions for said baseline group at said first plurality of merchants during said predetermined time period by a number of members of said baseline group to obtain said first one of said respective baseline values; and
calculate a second one of said respective baseline values, to which said determined per-capita spending at said second plurality of merchants for said at least one payment card account for said predetermined time period is to be compared, wherein said calculating of said second one of said respective baseline values in turn comprises:
querying said database for transactions for said baseline group at said second plurality of merchants during said predetermined time period;
summing amounts of said transactions for said baseline group at said second plurality of merchants during said predetermined time period; and
dividing said summed amounts of said transactions for said baseline group at said second plurality of merchants during said predetermined time period by said number of members of said baseline group to obtain said second one of said respective baseline values.

22. The apparatus of claim 15, wherein said persistent storage device further stores in said non-transitory manner instructions which when loaded into said memory cause said at least one processor to be further operative to determine said overall healthiness index score for said at least one payment card account for said predetermined time period by:
dividing said determined per-capita spending at said first plurality of merchants for said at least one payment card account by a first of said respective baseline values to obtain a first partial index;
annexing a negative sign to said determined per-capita spending at said second plurality of merchants for said at least one payment card account and dividing same by a second of said respective baseline values to obtain a second partial index; and
taking an average of said first and second partial indices to obtain said overall healthiness index score for said at least one payment card account for said predetermined time period.

23. The apparatus of claim 15, wherein:
said instructions on said persistent storage device comprise a database management system module and an analysis engine module;
said at least one processor is operative to access said database of payment card transaction data and said database of merchant data by executing said database management system module;
said at least one processor is operative to determine said per-capita spending at said first and second pluralities of merchants for said at least one payment card account for said predetermined time period by executing said database management system module and said analysis engine module; and
said at least one processor is operative to determine said overall healthiness index score for said at least one payment card account for said predetermined time period by executing said analysis engine module.

24. An article of manufacture comprising a non-transitory computer-readable storage medium storing instructions which when executed by a processor causes said processor to be operative to:
access a database of payment card transaction data and a database of merchant data;
determine per-capita spending at a first plurality of merchants for at least one payment card account for a predetermined time period, said first plurality of merchants having transaction data in said database of payment card transaction data, patronizing said first plurality of merchants being associated with good cardholder health;
determine per-capita spending at a second plurality of merchants for said at least one payment card account for said predetermined time period, said second plurality of merchants having transaction data in said database of payment card transaction data, patronizing said second plurality of merchants being associated with bad cardholder health; and
determine an overall healthiness index score for said at least one payment card account for said predetermined time period, based on comparison of said determined per-capita spending at said first plurality of merchants for said at least one payment card account for said predetermined time period and said determined per-capita spending at said second plurality of merchants for said at least one payment card account for said predetermined time period to respective baseline values.

25. An apparatus comprising:
means for accessing a database of payment card transaction data and a database of merchant data;
means for determining per-capita spending at a first plurality of merchants for at least one payment card account for a predetermined time period, said first plurality of merchants having transaction data in said database of payment card transaction data, patronizing said first plurality of merchants being associated with good cardholder health;
means for determining per-capita spending at a second plurality of merchants for said at least one payment card account for said predetermined time period, said second plurality of merchants having transaction data in said database of payment card transaction data, patronizing said second plurality of merchants being associated with bad cardholder health; and
means for determining an overall healthiness index score for said at least one payment card account for said predetermined time period, based on comparison of said determined per-capita spending at said first plurality of merchants for said at least one payment card account for said predetermined time period and said determined per-capita spending at said second plurality of merchants for said at least one payment card account for said predetermined time period to respective baseline values.
